(19) United States
(12) Patent Application Publication
(10) Pub. No.: US 2015/0206081 A1
(43) Pub. Date: Jul. 23, 2015

(54) COMPUTER SYSTEM AND METHOD FOR MANAGING WORKFORCE OF EMPLOYEE

(71) Applicant: PANASONIC INTELLECTUAL PROPERTY MANAGEMENT CO., LTD., Osaka (JP)

(72) Inventors: Kuo-Chu LEE, Princeton Junction, NJ (US); Michio MIWA, Chiba (JP); Hasan Timucin OZDEMIR, Plainsboro, NJ (US); Lipin LIU, Belle Mead, NJ (US); Jannite YU, Cranbury, NJ (US)

(73) Assignee: PANASONIC INTELLECTUAL PROPERTY MANAGEMENT CO., LTD., Osaka (JP)

(21) Appl. No.: 14/674,338

(22) Filed: Mar. 31, 2015

Related U.S. Application Data
(63) Continuation of application No. 13/194,010, filed on Jul. 29, 2011.

(51) Int. Cl. G06Q 10/06; H04N 7/18

(52) U.S. Cl. CPC G06Q 10/06311; H04N 7/183

(57) ABSTRACT

A computer system for managing a workforce includes a camera that captures a video in a retail store, and a computer connected to the camera, wherein when the computer determines that there is a customer not being assisted by an employee and lingering in a particular place in the store based on the video captured by the camera in the store, the computer directs the employee or another employee to assist the customer lingering in the particular place while prioritizing the customer lingering in the particular place over another customer lingering in a place other than the particular place.

### CROSS-REFERENCE TO RELATED APPLICATION

This is a continuation application of U.S. patent application Ser. No. 13/194,010, filed Jul. 29, 2011. The disclosure of the above-identified application, including the specification, drawings, and claims, is expressly incorporated herein by reference in its entirety.

### BACKGROUND

1. Field of the Disclosure

The present disclosure relates to the field of data mining. More particularly, the present disclosure relates to data mining for improving site operations by detecting abnormalities.

2. Background Information

In a retail store or other site, workers and managers conduct multiple tasks and interact with customers based on designed work flow patterns to achieve efficient operation. While the work flow procedures cover frequently occurring patterns, abnormal situations periodically occur and cause service interruptions or customer complaints, resulting in the loss of sale opportunities.

In a store environment, some establishments have various systems that generate event logs including point-of-sale (POS), surveillance, access control, and the like. Current surveillance recorders can record camera video with limited event types related with surveillance devices such as motion detection, video loss, etc.; however, there are no surveillance recorders that can easily and readily accept various types of event sources, record, manage, index, and retrieve these events. Store managers not only need to monitor events and incidents from these systems, but they also need to manage employees' daily operations. Retail stores must rely on store managers to handle all the incidents via manually combining POS log; access control log; video surveillance alarm log; and searching and figuring out what went wrong. Although there may be partly-integrated systems available such as climate control with video surveillance, there is no easy way to quickly search and display all the correlated events and sequences from all events. For example, taking just the surveillance recorder alone, user interfaces are designed based on the assumption that the store will have the resources to monitor the surveillance recorder; however, many small to medium-sized businesses (SMBs) do not have such resources and time to monitor the user interface at all, while they are in need of surveillance technology.

Surveillance recorders available today can record video based on the occurrences of certain event types, such as, for example, motion detection and the like. Although users can combine several event types in the search criteria for access and retrieval of video, there is no system available to automatically perform mining and correlate all sub-events with certain high abnormal events (alarms) together, and manage these related events as a composite event log. Such conventional systems are described in, e.g., U.S. Pat. No. 7,667,596 and U.S. Patent Publication No. 2010/0208064, the disclosures thereof being expressly incorporated by reference in their entireties.

Current video surveillance systems can provide customer location and arrival information (based on, e.g., traffic in aisle or are in a camera's field-of-view). The information collected from multiple cameras are connected; however, the system is often unable to distinguish between a single person transitioning from one camera to another, and two different people, causing accuracy problems. Similarly, tracking of an object may be lost due to tracking errors or a moving object merging into the background, or the same object appears with a different identifier and system considers it a different object/person instead of the track of the same person.

Currently, there is no available system to systematically conduct abnormal event analysis in a practical, systematic manner. Thus, such analysis cannot be done systematically by a worker working on tasks defined in the normal work flow.

Further, no available system exists that can correlate individual systems, such as a security system, unified communication (UC) system, online ordering system, facility management system, access control system, face recognition system, radio-frequency identification (RFID) system, customer relations management (CRM) system. Nor can any available systems correlate integrated applications, such as, for example video analysis+security, video Analysis+marketing, POS+video analysis (e.g., phantom returns), wireless ordering system+POS, face recognition (age, gender)+POS+CRM; and UC+access control+security. As used herein “UC” is defined as the integration of real-time communication services such as instant messaging (chat), presence information, telephony (including IP telephony), video conferencing, data sharing (including web connected electronic whiteboards aka IWB's or Interactive White Boards), call control and speech recognition with non-real-time communication services such as unified messaging (integrated voicemail, e-mail, SMS and fax).

Due to the lack of integrated systems to monitor site operations, organized retail crime groups exploit security vulnerabilities of retail establishments (such as chain stores) and repeat their act on different branches of the same establishment. When closed circuit television (CCTV) is used, each branch has recorded video. However, LP (Loss Prevention) personnel must individually review these lengthy videos and determine patterns such as whether individuals are the same in different videos/establishments. Some solutions pull incident video data to a central server to make LP investigation easier, such as VSaaS (Video Surveillance as a Service solution), but such solutions still require manual investigation to be done by individuals, who may not be able to accurately remember the contents of all the videos watched.

The current integrated solutions are vertically integrated and not open such as (integration of POS and recorder, integration of speed detection and recording, integration of door contact with camera recording, etc.). Unfortunately, all these integrations are generally through wired connections and are not scalable and flexible.

In known drive-thru operation sites (e.g., a fast-food restaurant) order processing typically occurs in the following order: the taking of the order, food preparation, accepting payment, and giving the order to customer. Different sites design and combine these steps in different ways so that service windows match the task sequence. The order taking is generally handled by an audio call to employee on the floor with a headset. The employee accepts the order and enters it into an order processing system. The customer pick-up window(s) handles payment and serving of order. Unfortunately, store pick-up windows are also vulnerable to employee theft. Considering that more than 50% of the operating cost are often due to labor costs in drive-thru operations, any automation in order processing workflow will improve the financial bottom line.

In view of the above, there has thus arisen a need to cohesively organize received multimedia information (e.g., POS terminal, unified communication device, customer relations manager, sound recorder, access control point, motion detector, biometric sensor, speed detector, temperature sensor, gas sensor and location sensor) for a site's applications, as well as related event information, for situation awareness and incident management. There has also arisen a need to be able to search the captured content (from, e.g., cameras) annotated by various data obtained from external devices. Unfortunately, heretofore the integration by connecting other devices with a multimedia recorder is not feasible considering the many applications at a retail site (e.g., doors, POS, CO sensors, etc.).

### SUMMARY OF THE DISCLOSURE

By focusing on abnormality management efficiency, a non-limiting feature of the disclosure improves the total system efficiency because the occurrences of abnormalities in operations are strong indicators of inefficiencies of otherwise optimized operation flow in, e.g. managed chain stores.

According to a non-limiting feature of the disclosure, provided is a method for monitoring and controlling the work flow process in a retail store by automatically learning normal behavior and detecting abnormal events from multiple systems.

A non-limiting feature of the disclosure automates the analysis and recording of correlated events and abnormal events to provide real-time notification and incident management reports to a mobile worker and/or managers in real-time.

A non-limiting feature of the disclosure provides a system that can record and manage multiple events efficiently and also can provide business intelligence summary reports from multimedia event journals.

A non-limiting feature of the disclosure organizes and stores correlated events as an easily-accessible event journal. A non-limiting feature of the disclosure provides that the surveillance recorder is to be integrated with a unified communication system for real-time notification delivery as well as a call-in feature, to check the site remotely when needed.

In a non-limiting feature of the disclosure, the networked services with secure remote access allows, e.g., a store manager to monitor many stores (thereby increasing efficiency for chain stores since one manager can monitor plural stores) and saves the manager from making a trip to each store every day. Rather, the manager can spend most of his/her time monitoring the multiple site operations to improve customer service and store revenue instead of driving to each store locations, which otherwise wastes energy and time.

Therefore, a monitoring and notification interface according to a non-limiting feature of the disclosure provides an easy-to-comprehend, filtered and aggregated view of multimedia and event data pertinent to application's objectives.

A non-limiting feature of the disclosure provides easy creation of application-specific recorded multimedia annotation (through event sources such as POS, motion sensor, light sensor, temperature sensor, door contact, audio recognition, etc.) allows a user to define application specific events (customization, flexibility), define how to collect the annotation data from events; and to retrieve all incident-related multimedia data efficiently in a unified view (resulting in automation efficiency).

A non-limiting feature of the disclosure integrates different types of events to create a unified data model to allow for service process optimization and reduces the service and waiting time for the customer. A non-limiting feature of the disclosure focuses on abnormality detection management to improve the store operation based on normal customer demand to detect an abnormal event sequence and cross relationship of event sequences.

A non-limiting feature of the disclosure provides a data mining process that supports staffing decisions based on expected customer demand extracted from prior data collected from video based detection (counting, detecting balked customers), POS, and staff performance data (indicative of service levels for certain preparation tasks).

A system according to a non-limiting feature of the disclosure automatically creates event correlation based recordings, and generates video journals that are easy for workers and managers to view without significant manual operation. The recorded multimedia journal in a non-limiting feature of the disclosure includes multiple types of events and event correlations that are ranked, to facilitate fast browsing.

A non-limiting feature of the invention reduces the integration cost by only integrating abnormal events, thereby saving time. Also, customization costs may be reduced by extracting a normalized abnormal score from different system variables with different meaning and units.

An abnormality business intelligence report according to a non-limiting feature of the disclosure reduces the need to manually observe a long duration progressive change of fitness of optimization process of each system. Also, synchronizing the speed-up pace of a site worker in the order pipeline or addition of a worker when one is needed in real-time can reduce service wait time and total system cost.

A system according to a non-limiting feature of the disclosure can record multiple types of events and multimedia information besides video from various event information sources. The recorded information is organized and indexed not only based on time and event types, but also based on multiple factors such as correlated events, time, event sequences, spatial (location), and the like.

A system according to a non-limiting feature of the disclosure allows users to define a business intelligence application context to express application objectives for automated event journal organization.

A system according to a non-limiting feature of the disclosure captures event inputs with multimedia recording from multiple event sources, filters and aggregates the events. An event sequence mining engine performs event sequence mining, correlates the events with forward and backward tracking event sequence linkages with probability, and event prediction.

A system according to a non-limiting feature of the disclosure provides an automated online unified view with a summary dashboard for fast chain store business intelligence monitoring, and the retrieved multimedia recording is based on key events and can be easily browsed with all the linked sub events along the time, spatial, and chain store location (single/city/region/state/worldwide) scope. A system according to a non-limiting feature of the disclosure also seamlessly integrates automated notification via unified communication.

A system according to a non-limiting feature of the disclosure provides a multimedia event journal server supporting multi-model time-spatial event correlation, sequence mining, and sequence backtracking for daily business management event journaling and business intelligence for retail employee management, sales management, and abnormal incident management.

A multimedia event journal server according to a non-limiting feature of the disclosure can collect and record events, aggregate events, filter events, mining sequence of events, and correlate events from multiple types of event input sources in retail store business operations. It provides automated online real-time abnormal correlated events journal with business intelligence summary unified reporting view or dashboard and unified communication notification to store managers via computer or mobile device.

The event journal server system provides event collection via event APIs (application programming interfaces), an event sequence mining and correlation engine, multimedia storage for event and transaction journals, event journaling management, business intelligence summary reporting, and alert UC notification.

Features of an integrated abnormality detection system according to a non-limiting aspect of the disclosure are:
reduction of integration costs by only integrating abnormal events;
reduction of customization costs by extracting a normalized abnormal score from different system variables with different meaning and units;
an abnormality business intelligence report reduces the need for an employee to manually observe a long duration progressive change over time in order to determine the optimization process of each system; and
synchronizing the increase in work pace of a worker in an order pipeline, or adding a worker when needed in real-time, can reduce customer service wait time and total system cost.

The system allows users to define business intelligence contexts to express application objectives, and captures event inputs from devices with multimedia recording from multiple types of devices or sensors, combines events and sequences, and provides flexible notification via unified communication (UC), and supports an online real-time unified summary view dashboard for fast search and monitoring.

A multimedia event journal server according to a non-limiting feature of the disclosure provides an extensible system that allows integration of various events for application-specific composite event definition, detection, and incident data collection. The flexible framework allows the user to see all event related data in a unified view. The presentation layer can be customized for vertical application segments. An application event capture box may provide broadband connection to cloud-based services which can allow maintenance, configuration data backup, incident data storage for an extended period of time (instead of on-site recorders), business intelligence reports, and multi-site management.

The system according to a non-limiting feature of the disclosure receives the raw events from one single device or from multiple devices or sensors, which are then accumulated to detect application composite events which are composite of correlated events. Also, the system may perform event sequence “occurrence interval” statistic distribution based on either multi-step Markov chain model learning or Bayesian Belief network learning methods. After the system learns, the statistical linkages of events are automatically constructed and abnormal sequence based on time and space as well as “multiple previous events” can be backtracked.

Another feature of the system traces back all the abnormal events after one abnormal event has occurred. The results may be ordered based on the ranked abnormality score of the events. Also, managed events data and video may be provided to additional networked central management sites. The recorded multimedia may be annotated with the collected composite event information (e.g., allow a user to jump to a segment in which a selected grocery item has been scanned instead of watching the whole recording for investigation). Also, storing data from a security guard while the guard is annotating/evaluating an incident video may be performed because in the case where fraud is internal and organized, the searches on various abnormalities (including the annotations from guards) becomes important to discover internal fraud attempts, assuming that subjects will likely to cover traces in a surveillance system. In addition, the system can mine the assessment of guard/security officer with respect to a set of face feature data (extracted from LP records) to see whether there is any correlation between, e.g., the officer ID, cluster of faces, and assessment of LP record, thereby allowing a user to determine whether, e.g. a set of LP records (containing the set of same face feature vector sets) getting favorable assessment from a certain security guard. Further, the system may query assessment of LP cases by multiple security guards to cross-check the assessment honesty or deviations. For further review (or randomly), the system can flag certain LP case assessments by a certain security officer based on detected abnormalities. The system can hypothesize and open a virtual case for the aforementioned situation (kind of a hunch) and start collecting evidence, until there is substantial evidence to notify the supervisor to take a look at the virtual case file for human (supervisor) inspection.

Also, the system in accordance with a non-limiting feature of the disclosure may further include representing application-specific events based on raw events and their potential sequencing. Also provided may be detection representation combining the many events in representation for efficiency. Also, the defined application specific events may be dynamically updated (e.g., they may be added, deleted or modified) and stored in dynamic or permanent storage.

Major cost burdens in retail industry come from theft, return fraud and false injury/workman's compensation claims. Thus, a non-limiting aspect of the disclosure provides a feasible and efficient way to:
a. record these events,
b. correlate and determine which abnormal events occurred based on event sequences,
c. remotely monitor the correlated events and media contents,
d. organize for fast search of event information data,
e. retrieve and display correlated information of a particular event with annotation, and/or
f. provide an alarm notification event flexibly and efficiently.

The system in accordance with a non-limiting feature of the disclosure provides an easy-to-use customization framework for users and solution providers to integrate various multimedia devices within a unified framework which enables efficient annotation of captured content with associated captured metadata.

The integration of multiple types of multimedia devices and sensor event capture modules allow an event mining module to learn abnormal operation patterns and/or events, including but not limited to the following:
a. POS open pattern,
b. UC call pattern
c. POS open event when system detects site or store is closing or closed,
d. System detects an abnormal amount of cash left in POS device when the store is closing or closed,
e. System detects that the removable cash box has been left in POS device when the store is closing or closed, and/or
f. System detects that heater/oven/HVAC/etc is open or turned on when the store is closing or closed.

When any of the above abnormal operations are observed by the system, the system has the ability to generate alerts or alarms.

The system in accordance with a non-limiting feature of the disclosure can provide online real-time event sequence journal and business intelligence summary reports and a dashboard with the scope of single store to multiple stores for store owners, as well as countrywide or global summary views for headquarters for business intelligence and sales analysis.

The system in accordance with a non-limiting feature of the disclosure performs event sequence mining and correlation to sensed events and generates alarms for correlated events. The system in accordance with a non-limiting feature of the disclosure manages events data and links related events together for alarms with unified views and annotation on video for easy access and playback display. During monitoring, the system in accordance with a non-limiting feature of the disclosure uses selected context to combine the video from the select regions of interest (ROIs) of each video mining scoring engine target (associated with a camera) and external data (POS transactions) into one unified view. For notification, the system in accordance with a non-limiting feature of the disclosure uses the selected context for delivery of notification with unified communication or unified view portal when the application specific complex event is recognized.

Context may be used as a mechanism to define the application-specific filtering and aggregation of video, audio, POS, biometric data, door alarm, etc. events and data into one view for presentation. With the help of context, the user only sees what the application requires. The context definition includes a set of video mining agent (VMA) scoring engines with their ROIs, complex event definition based on primitive events (POS, door alarm events, VMA scores, audio events, etc.).

A unified view portal provides a synchronized view of disparate sources in an aggregate view to allow the user/customer to understand the situation easily. Automated notification capability via unified communication to send external (offsite) notifications when an alarm is detected.

The system in accordance with a non-limiting feature of the disclosure with UC compatibility allows outside entities to login to the system and connects to devices for monitoring, maintenance, upgrade etc. purposes as well as communications.

An aspect of the disclosure also provides a system of store management by using face detection and matching for queue management purposes to improve site/store operations. Such a system may include a system to detect a face, extract a face feature vector, and transmit face data to a customer table module and/or a queue statistics module. Also included may be a system to collect and send POS interaction data to queue statistics module, as well as a system (such as a customer table module) to judge whether the received face is already in a customer table of the queue. Also provided may be a system (such as a queue statistics module) to: annotate video frame with POS events/data and face data (which may be part of metadata), obtain the customer arrival time to queue from a customer table module, obtain cashier performance data from a knowledge base, insert the cashier performance for each completed POS transaction to a data warehouse, assess the average customer waiting time for each queue, and send real-time queue status information to a display.

The display may display real-time queue performance statistics and visual alerts to indicate an increased load on a queue based on the real-time queue status and the cashier's expected work performance. The display may also communicate each queue status to an individual such as a manager by at least one of visual and audio rendering.

Additionally, the system to detect a face may be able to select a good-quality face feature to reduce the amount of data to be transferred, while increasing the matching accuracy. Also, the system to judge whether the received face is already in the customer table of the queue may select a set of good face representatives to reduce the required storage and increase matching accuracy. Further, annotated video frame data may be saved in an automated multimedia event journal server, linked by their content similarity by the automated multimedia event server, accessed by the display from the automated multimedia event server to browse the linked video footage to extract the location of the customer prior to entering to the queue.

Accordingly, a non-limiting feature of the disclosure provides a system for improving site operations by detecting abnormalities, having a first sensor, a first sensor abnormality detector connected to the first sensor, and configured to learn a first normal behavior sequence based on detected data sent from the first sensor, the first sensor abnormality detector having a first scorer configured to assign a normal score to first sensor data corresponding to the learned normal behavior sequence and an abnormal score to first sensor data having a value outside of the value of the first sensor data corresponding to the learned normal behavior sequence, a second sensor, a second sensor abnormality detector connected to the second sensor, and configured to learn a second normal behavior sequence based on detected data sent from the second sensor, the second sensor abnormality detector having a second scorer configured to assign a normal score to second sensor data corresponding to the learned normal behavior sequence and an abnormal score to second sensor data having a value outside of the value of the second sensor data corresponding to the learned normal behavior sequence, an abnormality correlation server configured to receive abnormally scored first sensor data and abnormally scored second sensor data, the abnormality correlation server further configured to correlate the received abnormally scored first sensor data and abnormally scored second sensor data sensed at the same time by the first and second sensors and determine an abnormal event, and an abnormality report generator configured to generate an abnormality report based on the correlated received abnormally scored first sensor data and abnormally scored second sensor data. The first sensor and the second sensor may be different sensor types and generate different types of data. Also, at least one of the first sensor and the second sensor is a video camera.

Also, a non-limiting feature of the disclosure provides a system wherein at least one of the first sensor abnormality detector and the second sensor abnormality detector has a memory configured to records sensor data, the recorded sensor data having distribution of sensor variables and metadata of event frequency, and the at least one of the first sensor abnormality detector and the second sensor abnormality detector is configured to detect a change of the distribution and a change of the metadata over time. Also provided may be a protocol adapter positioned between the first and second sensors and the first and second sensor abnormality detectors.

Also provided may be an intervention detector connected to the abnormality correlation server and configured to detect whether an abnormal event has been acknowledged by an entity external to the system. A pager connected to the abnormality report generator and configured to send an alert to a user when the abnormality report is generated may also be provided.

Further, a non-limiting feature of the disclosure provides at least one non-transitory computer-readable medium readable by a computer for improving site operations by detecting abnormalities, the at least one non-transitory computer-readable medium having a first sensor abnormality detecting code segment that, when executed, learns a first normal behavior sequence based on detected data sent from a first sensor, the first sensor abnormality detecting code segment having a first scoring code segment configured to assign a normal score to first sensor data corresponding to the learned first normal behavior sequence and an abnormal score to first sensor data having a value outside of the value of the first sensor data corresponding to the learned first normal behavior sequence, a second sensor abnormality detecting code segment that, when executed, learns a second normal behavior sequence based on detected data sent from a second sensor, the second sensor abnormality detecting code segment having a second scoring code segment configured to assign a normal score to second sensor data corresponding to the learned second normal behavior sequence and an abnormal score to second sensor data having a value outside of the value of the second sensor data corresponding to the learned second normal behavior sequence, an abnormality correlation code segment that, when executed, receives abnormally scored first sensor data and abnormally scored second sensor data, the abnormality correlation code segment further configured to correlate the received abnormally scored first sensor data and abnormally scored second sensor data sensed at the same time by the first and second sensors and determine an abnormal event, and an abnormality report generating code segment that, when executed, generates an abnormality report based on the correlated the received abnormally scored first sensor data and abnormally scored second sensor data.

In a non-limiting feature of the disclosure, the first and second sensors are different types, or at least one of the first and second sensors is a video camera. Also, at least one of the first sensor abnormality detecting code segment and the second sensor abnormality detecting code segment, that when executed, actuates a memory configured to record sensor data, the recorded sensor data having distribution of sensor variables and metadata of event frequency, and the at least one of the first sensor abnormality detecting code segment and the second sensor abnormality detecting code segment, when executed, detects a change of the distribution and a change of the metadata over time.

Also provided may be an intervention detecting code segment that, when executed, detects whether an abnormal event has been acknowledged by an external entity. Still further provided may be a paging code segment that, when executed, sends an alert to a user when the abnormality report is generated.

According to a non-limiting feature of the disclosure, a method is provided, including learning a first normal behavior sequence based on detected data sent from a first sensor, assigning a normal score to first sensor data corresponding to the learned normal behavior sequence and an abnormal score to first sensor data having a value outside of the value of the first sensor data corresponding to the learned first normal behavior sequence, learning a second normal behavior sequence based on detected data sent from a second sensor, assigning a normal score to second sensor data corresponding to the learned normal behavior sequence and an abnormal score to second sensor data having a value outside of the value of the second sensor data corresponding to the learned second normal behavior sequence, receiving abnormally scored first sensor data and abnormally scored second sensor data, correlating the received abnormally scored first sensor data and the received abnormally scored second sensor data sensed at a same time by the first and second sensors and determining an abnormal event, and generating an abnormality report based on the correlated received abnormally scored first sensor data and the abnormally scored second sensor data. Also, the first and second sensors may be positioned at different regions of the site.

In yet another non-limiting feature of the disclosure, a method of processing an order from a mobile device is provided, including, detecting at least one nearest facility based on a location of the mobile device, communicating the detected at least one more nearest facility to a user, selecting a detected facility of the at least one nearest facility, selecting at least one item from items available for purchase at the selected detected facility, sending an order for the at least one item to a site for order processing, and receiving a confirmation of the ordered at least one item. The method may further include sending payment for the one or more items.

According to still another non-limiting feature of the disclosure, a method for verifying an identity of a customer picking up an order at a site, including receiving an order from a mobile device, the order including customer identification data, generating an order confirmation for the customer, and associating the customer identification data with the order confirmation. The customer identification data may include vehicle tag data, and the method may further include detecting the vehicle tag data upon arrival of a vehicle of the customer at the site, determining a sequence of vehicles arriving at the site, and preparing customer orders corresponding to the sequence of the vehicles arriving at the site.

Further, the method may include obtaining a location of the customer, estimating a time of arrival of the customer, and preparing the order based on the estimated time of arrival of the customer. Also, the method may also include sending an image of a worker of the site to the customer; and routing the customer to the worker corresponding to the sent image upon the customer's arrival at the site.

According to yet another non-limiting feature of the disclosure, a method for preventing merchandise loss at a site may be provided, including storing video recordings of a plurality of videos, each video of the plurality of videos including video images and metadata of the video image, the metadata including data corresponding to a face value of a unique face, comparing face values of the plurality of videos, obtaining a degree of correlation between a face value of one video of the plurality of videos and a face value of another video of the plurality of videos, and generating a report when a predetermined correlation threshold is reached between the one video and the another video.

Also, in another feature, the metadata further includes at least one of video recording time interval and camera field of view, the method further including comparing the at least one video recording time interval and camera field of view to obtain a composite value; and obtaining a degree of correlation between composite values of the one video of the plurality of videos and composite values of the another video of the plurality of videos.

In another a non-limiting feature of the disclosure, a method of managing a workforce at a site is provided, the method including monitoring the location of at least one employee at the site, monitoring the location of at least one customer at the site, determining a positional relationship between the at least one employee and the at least one customer, determining that the at least one customer is being assisted by the at least one employee when the determined positional relationship is within a predetermined value range, determining that the at least one customer is not being assisted by the at least one employee when the determined positional relationship is outside of the predetermined value range and generating a report when the determined positional relationship is outside of the predetermined value range.

The monitoring a location of at least one customer at the site may include monitoring locations of a plurality of customers, the method further having determining a period of time each customer is not assisted by the at least one employee. Also, the monitoring a location of at least one customer at the site may include monitoring locations of a plurality of customers, the method further having determining a site arrival time of each customer that is not being assisted by the at least one employee.

A further non-limiting feature of the disclosure provides a method of determining an identity of a customer at a site, the method including detecting, using at least one video imager, a unique customer based on a customer face at the site based on face data corresponding to a face value of a unique face, obtaining unique customer data at a point of sale terminal of the site, the unique customer data including at least customer name and previously stored face data, and comparing the detected face data with the previously stored face data and determining whether the identity of the unique customer corresponds to the unique customer data.

### BRIEF DESCRIPTION OF THE DRAWINGS

FIG. 1 is an illustrative embodiment of a general purpose computer system, according to an aspect of the present disclosure;

FIG. 2 is a schematic view of an Abnormality Detection Agent and Server, according to an aspect of the present disclosure;

FIG. 3 is another schematic view of an Abnormality Detection Agent and Server, according to an aspect of the present disclosure;

FIG. 4 is a schematic view of the abnormality correlation server, according to an aspect of the present disclosure;

FIG. 5 is a flowchart showing a method of workforce management, according to an aspect of the present disclosure;

FIG. 6 is a schematic view of location-aware order handling, according to an aspect of the present disclosure;

FIG. 7 is a schematic view showing a system for workforce management using face tracking, according to an aspect of the present disclosure;

FIG. 8 is a system for face detection and matching using multiple cameras, according to an aspect of the present disclosure;

FIG. 9 is a system of customer verification, according to an aspect of the present disclosure;

FIG. 10 illustrates a customer being identified after receiving an order code, according to an aspect of the present disclosure;

FIG. 11 is a schematic view wherein a sequence of customer orders are arranged based on the customer sequence of arrival, according to an aspect of the present disclosure;

FIG. 12 is a schematic of a linked loss prevention system, according to an aspect of the present disclosure;

FIG. 13 is a schematic of frames of a loss prevention system, according to an aspect of the present disclosure;

FIG. 14 is a schematic of frames of a loss prevention system, according to an aspect of the present disclosure;

FIG. 15 is a schematic view of a queue management system, according to an aspect of the present disclosure;

FIG. 16 is a system for personalized advertisement and marketing effectiveness by matching object trajectories by face set, according to an aspect of the present disclosure;

FIG. 17 is a schematic view showing an event journal server, according to an aspect of the present disclosure;

FIG. 18 is an exemplary view of a business intelligence dashboard, according to an aspect of the present disclosure;

FIG. 19 is a schematic view of a composite event, according to an aspect of the present disclosure;

FIG. 20 is an event journal server data model, according to an aspect of the present disclosure; and

FIG. 21 is an event journal interface data schema, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

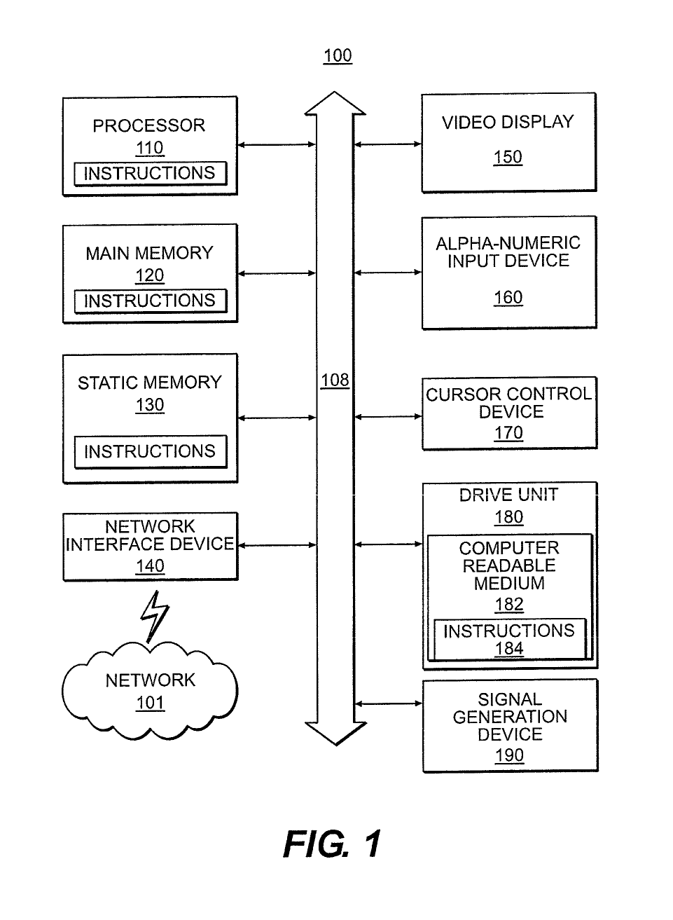

Referring to the drawings wherein like characters represent like elements, FIG. 1 is an illustrative embodiment of a general purpose computer system, on which a system and method for improving site operations by detecting abnormalities can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

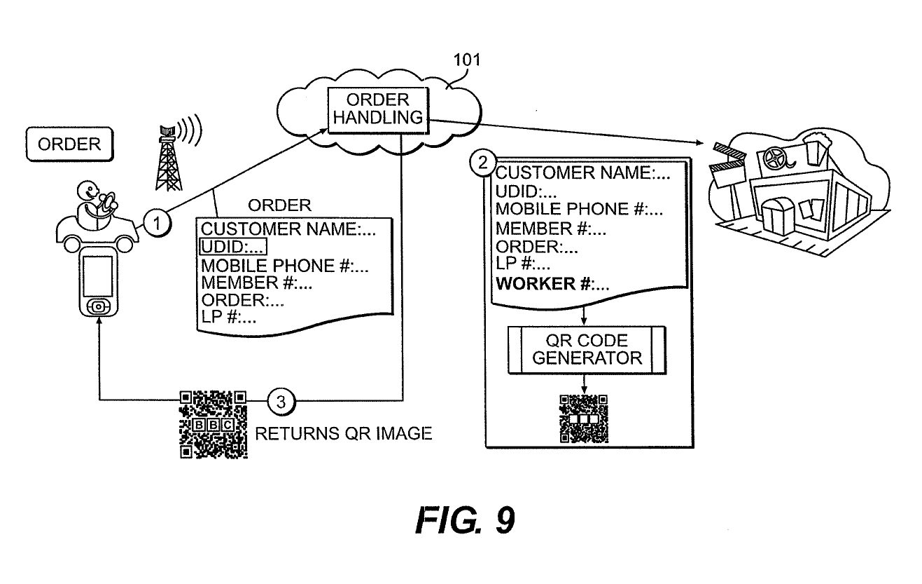

In a networked deployment, the computer system may operate in the capacity of a server or as a client user computer in a server-client user network environment, or as a peer computer system in a peer-to-peer (or distributed) network environment, including but not limited to femtocells or microcells. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, smartphone 76 (see FIG. 9), a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display (video display unit) 150, such as a liquid crystal display (LCD), an organic light emitting diode (OLED), a flat panel display, a solid state display, or a cathode ray tube (CRT). Additionally, the computer system 100 may include an input (input device) 160, such as a keyboard or touchscreen, and a cursor control/pointing controller (cursor control device) 170, such as a mouse or trackball or trackpad. The computer system 100 can also include storage, such as a disk drive unit 180, a signal generator (signal generation device) 190, such as a speaker or remote control, and a network interface (e.g., a network interface device) 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which one or more sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 104 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video and/or data over the network 101. Further, the instructions 184 may be transmitted and/or received over the network 101 via the network interface device 140.

Abnormality Detection Agent and Server

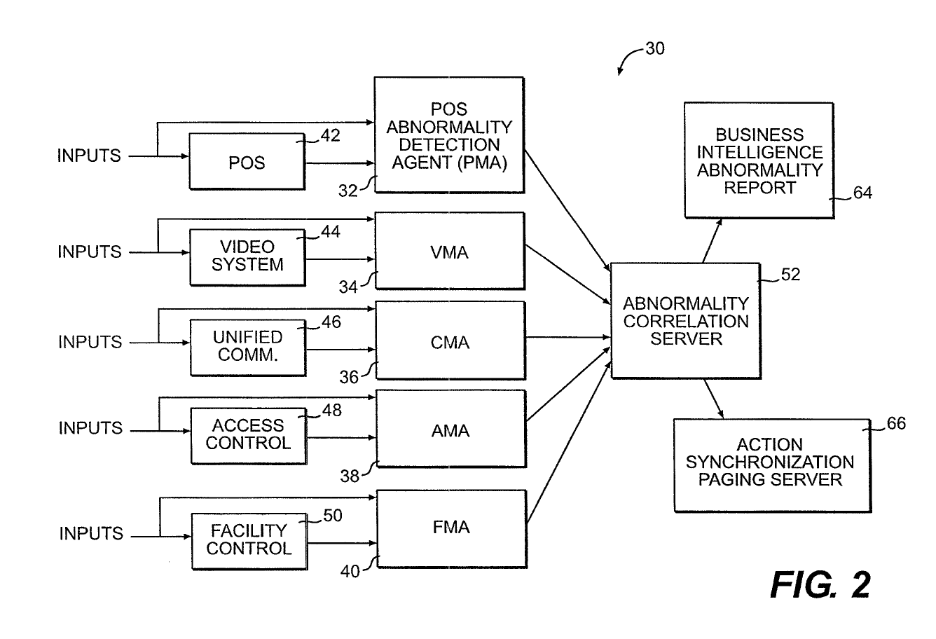

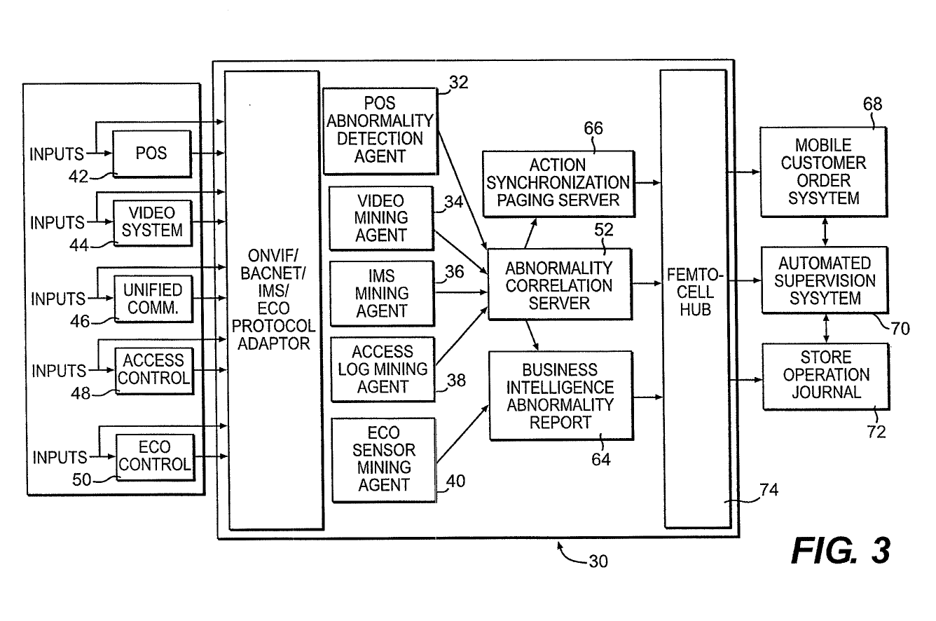

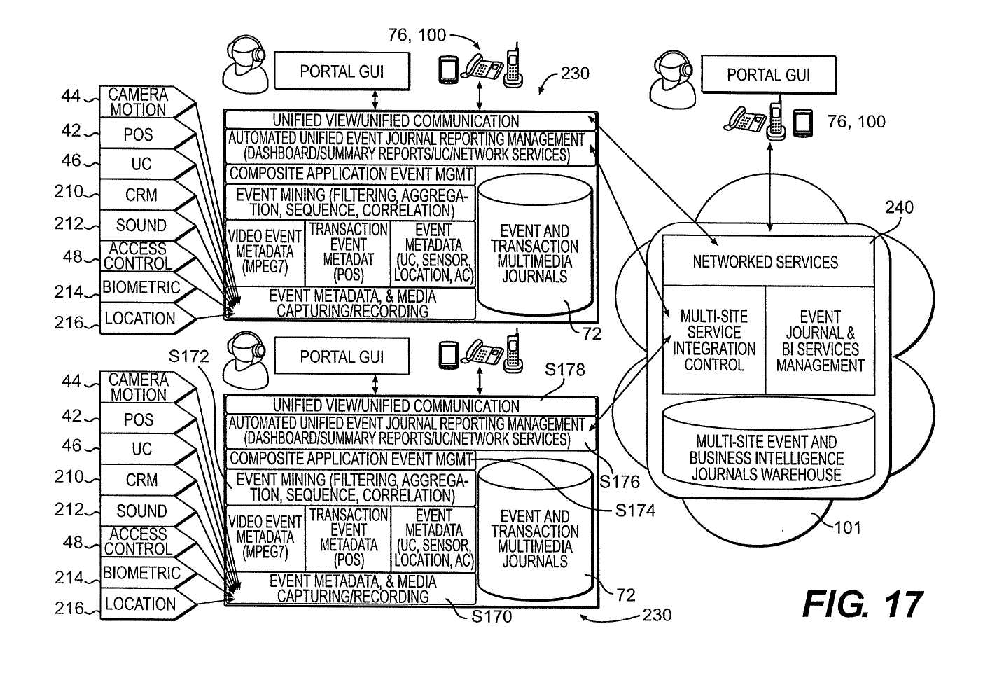

FIGS. 2-3 show a schematic view of an Abnormality Detection Agent and Server (ADS) 30 in accordance with an aspect of the disclosure. The ADS includes agents 32, 34, 36, 38 and 40 for extracting abnormal input and output events from a set of inputs and outputs of each isolated sensor 42, 44, 46, 48, 50. Exemplary sensors are point of sale (POS) 44, video 44, unified communication (UC) 46, site access control 48 and facility/eco control 50; however, those of skill in the art should appreciate that a variety of other types of sensors may also be used in other aspects of the invention (as shown, e.g., in FIG. 17), including but not limited to still camera, customer relations manager (CRM) 210, sound recorder 212, infrared motion detector, biometric sensor 214, speed detector, temperature sensor, gas sensor, location sensor 216 and the like. Each sensor 42, 44, 46, 48, 50 is connected to a respective corresponding agent, namely a POS abnormality detection agent (PMA) 32, a video abnormality detection agent (also referred to a video mining agent, or VMA) 34, a UC abnormality detection agent (CMA) 36, an access control abnormality detection agent (AMA) 38 and a facility control abnormality detection agent (FMA) 40.

The agents 32, 34, 36, 38 and 40 are each connected to an abnormality event sequence correlation server (ACS) 52, schematically shown in FIG. 3, which automatically learns sequence patterns and detects abnormal event sequences, known as event sequence mining.

The auto-learning step includes two step processes. First, each agent 32, 34, 36, 38 and 40 collects event data from its respective sensor 42, 44, 46, 48, 50 used at a site and learns a normal pattern from a selected subset of the input and output of a selected sensor 42, 44, 46, 48, 50. Each event is given an abnormality score. The data mining is done automatically without human intervention. After the abnormality score is generated, only medium and high abnormal scores are sent to the abnormality event sequence correlation server (ACS) 52, schematically shown in FIG. 3. The ACS 52 translates the abnormal activities (e.g., abnormal customer order requests) using a mining agent which scores the abnormal behavior based on the abnormality that the behaviors of, e.g., a customer, a worker, or a drive thru car in the form of time-space distributions. Once the event is ranked based on the score, it establishes a common reference for the abnormality between different types of the events.

Secondly, the ACS 52 detects the meta properties (e.g., abstract value meta data (AVMD) 54) such that the dynamic and bursty distribution can be analyzed beyond the stationary distribution. The meta property of the score abnormal events is based on occurrences, inter-arrival rate, and correlation of the events of different types. The ACS 52 also performs cross arrival distribution pattern learning and detects an abnormal cross relationship between the events. Also, the system (at, e.g., the front end) can use deep packet inspection to capture application-level messages. The sensor data output sequence is logged and learned as a statistical distribution of patterns, when the corresponding sequence between the different sensors 42, 44, 46, 48, 50 becomes different from the normal sequences in a moving window. For example, a(i), b(j), c(k) are abnormality behavior scores from sensors a, b, c. which can form a composite distribution. A correlation abnormality can be defined in many ways. One exemplary way may be L2 distances (Minkowski distance when p=2, a.k.a., Euclidean distance) of all possible ordered sequences weighted by the occurrence frequency of each type of sequence. RMS((A(i)-a(i), B(j)-b(j), C(k)-c(k)) for all the combinations of a(i), b(j), c(k). The system may then detect abnormal orders and magnitude of abnormal behavior value among multiple sensors 42, 44, 46, 48, 50. For sequences that have very low occurrences or very different scores, the correlator can issue a sequence of composite abnormal behavior values for each input event or in bundled events at controllable intervals. Also in order to obtain abnormality values, an algorithm of the system obtains a matrix where each row represents one of above sensor inputs, and a column is obtained by time intervals. The time window of the last columns defines a matrix which captures state information. To utilize symbolic sequence mining based algorithms, the system can collect such matrix data and apply clustering to discover clusters. Then, each cluster is assigned a symbol (cluster symbol). This multidimensional sequence data is converted to a sequence of symbols to apply sequence learning and detection of abnormalities based on expected sequence patterns. Another feature of the disclosure supports robustness for time length variations, and the above-described matrix can be obtained by different time window sizes (1 sec, 2 sec, 4 sec, etc.). Wavelet transform can also be applied to these matrix data to obtain vectors that can be utilized for clustering and cluster symbol assignment in the above sequence. These are exemplary methods to learn sequences and detect abnormalities by using discovered sequences.

Exemplary types of cross relationship abnormalities at a site (for example, a fast-food restaurant) include, for example sequence abnormalities such as: a car entering a drive-thru area but did not stop at ordering or pickup areas; a customer enters the store without going to the ordering area; many cars enter in a burst that is much higher than a normal service rate at the time of the day; and the time interval that a car stays in an entrance of the drive-thru is too long, indicating a long queue or car breakdown.

Exemplary types of cross relationship event sequence abnormalities include situations where: a car drives in to order the food without a POS transaction; a POS transaction occurs after a customer leaves or occurs earlier than the customer enters the POS/cashier area (signaling possible opportunity for a loss prevention event); the kitchen makes much more food than is needed for normal business hours; the number of customers that are not greeted by a sales person is higher than normal (indicating possible absence of sales associates); the rate of customers entering the store is higher than normal (as determined by VMA) but sales are lower than normal (as determined by POS); linger time of a customer in a predetermined section of the store is significantly longer than a customer linger time in other areas, but the pattern has changed (indicating that there is a change in interest or effectiveness of special promotion).

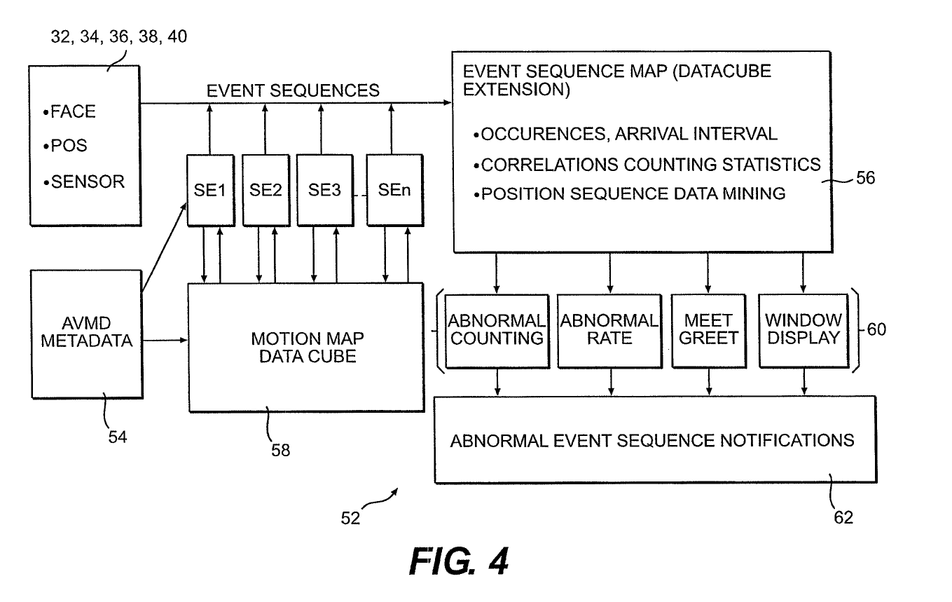

Thus, the ACS 52 collects different types of events from multiple systems used at a site and builds/updates multiple data models/maps 56 based on these events, as shown in FIG. 4. For example data from motion abnormality scoring engines SE1 . . . SEn received from the agents 32, 34, 36, 38 and 40 and AVMD 54 are correlated to generate a motion map data cube 58, which is then used to create the event sequence map 56. The event sequence map 56 is then used to identify abnormal events 60, and the system may be configured to generate a notification 62 or report of these abnormal events. The notification 62 is generated after the ACS 52 analyzes and correlates the events when the abnormal events happen. By identifying abnormalities across multiple systems, synchronization events may be triggered, notifying workers and/or managers via action synchronization paging server 66 to, e.g., speed up the customer service rate.

An abnormality business intelligence report system 64 (see, FIG. 3) can provide detailed information on the time and place that the abnormality event happens and signify the need for a change in site processes when the abnormality event frequencies increase.

An additional feature of the invention is scalability for adding additional abnormality score detection engines 52 based on, e.g., plug-and-play devices such as an advanced video motion tracking device (e.g., a tracker output object bounding box). Thus, the system is customizable to a user's needs.

As shown in FIG. 3, the ACS 52, the abnormality business intelligence report system 64, and an action synchronization paging server 66 may be connected to a mobile customer order system 68, an automated supervision system 70 and a store operation journal 72 (further described below) over the network 101 including a femtocell hub 74. As used herein, a femtocell is a device used to improve mobile network coverage in small areas. Femtocells connect locally to mobile devices through their normal connections, and then route the connections over a broadband interne connection back to the carrier, bypassing normal cell towers.

### Workforce Management

One proposed use of the system is for workforce management. For example, in a retail environment, the action synchronization paging server 66 can inform the retail store manager if a customer has been assisted by a sales staff member when the number of customers is fewer than the number of sales staff. However, when the number of customers is greater than the number of sales staff, the action synchronization paging server 66 may not generate an alarm or page. When the sales staff member wears a marker, RFID or other way to locate and identify him/her, the system can track how the sales person interacts with customers.

The system is also able to collect transaction data from multiple mobile devices such as cell phone or active tag (such as an RFID system). These mobile devices enable the system to obtain location information, which can be combined with video images via a through the operation journal 72. The operation journal 72 contains cumulative store operation event sequences and abnormality events automatically detected by the system and logged in the journal. The mobile device also collects transaction data from the mobile devices and active tag.

The collected transaction data may include, for example:
A. Data associated with when a device begins and ends operating at a location. Such transaction data may include items or services ordered or to be processed. For example, the system collects online ordering information from a mobile device and forwards it to a machine that can fulfill the order. Transactions, video based counting, video based balked customer detection, employee track records, may be based on order and RFID tracking.
B. Data associated with performance of each staff member may be generated and/or updated for completing each item. This continuously updated model captures the service time for each individual product by particular staff.
C. Data associated with customer demand based on time of day and day of week may be generated and/or updated for each product based on, e.g., cell phone transaction data and video-based data.
D. The proposed system learns the sequence of operations performed by staff in responding to on-line orders by combining data associated with RFID traces and data associated with order information (a cell phone transaction). This combined data is correlated with field-of-view of cameras through detection events to learn the snapshots when preparing certain orders. These sequences are used for building journals 72 (for, e.g., loss prevention) and detecting abnormalities when the expected sequence is not observed (and may provide a real-time alert to store manager). It is advantageous to detect differences in snapshot sequences, since one does not always need to record and process 30FPS (frames per second) video data, because there are often many redundancies in fast sampling rates when compared to the rate of movement of staff and other people.
E. When the data associated with staff performance and expected product demand and queue times are combined, the system can make a staffing decision while balancing the service time with the proper staff (e.g., the system does not need to assign the fastest staff to the drive-thru since system can schedule less experienced staff and still met the service level and use the more experience staff in other location in the same store).
F. The expected service/waiting time information is displayed real time to displays in front of the store as well as available online to customers to give some idea about the wait times at the drive thru.

To provide better customer service, the system is able to indicate which customer arrived at a site/store first. Emphasizing priority of arrival reduces “line-cutting” and customer aggravation. Such a system that produces data as to how long a customer spends time in the store provides a store with valuable insight about customer traffic.

The system collects multiple types of statistics from location information, estimated arrival time, and order processing workflow status. Using input and output of multiple sensors, the system can perform analyses that are not easy for a manager or worker to do manually, for example:
A. Abnormally fast arrival of vehicles beyond regular service rate in a drive-thru can be detected by video before the order is entered into the POS system. The system can alert the worker (who may be wearing special eyeglasses which also displays real-time store operations data, such as number of cars, and orders, or who may be viewing a real-time display to speed up a worker's order processing, etc.) to speed up the order processing rate or manager to put extra resources for the drive thru.
B. Abnormal order of large number of particular items (e.g., a hamburger), would require attention from kitchen to balance the large order with other shorter orders so that the large order does not block the order processing of other customers' orders.
C. Abnormally high balking rate (i.e., when a customer or vehicle bails out of an order queue) under the normal arrival may indicate that some site operation error might need attention.
D. Abnormal long arrival interval may be due to a traffic jam.
E. Abnormally high product return rate may have a high probability of a phantom return (e.g., when a customer receives a return form an item that was not actually returned) for loss prevention.
F. Abnormally low customer lingering time in a region of the site may indicate a problem with merchandise placement.

When abnormal events are determined, action can be automatically performed by the system, for example:
A. Based on the abnormality of high or low inventory and customer order patterns, the system can provide real-time notification to trigger promotion activities automatically. Paper or virtual promotion coupons could be delivered to opt-in loyalty customers (e.g., shoppers enrolled in a vendor's customer loyalty program, identified via, e.g., CRM) near the stores. The member customer profile can be used to see the up-sell and cross-sell opportunities with personalized coupon offers. A personalized coupon dispenser system may examine the current active order and compare with a member customer's preferences and current available inventory to identify the up-sell opportunity. For example, if a member customer normally orders coffee in the morning, but did not order this time, and there is a plentiful supply of coffee at the site, then a discount coupon for coffee for member customer could be presented by personalized coupon dispenser system (which, for example, can be sent to the member customer's mobile device application). The minimal inputs to the promotion system includes but is not limited to current order, kitchen status, and assessment of customer with churn models to predict her defection/switch. For example, the system may decide to provide a free drink (even though there is no expectation of oversupply in kitchen) because the system evaluates that the customer is about to defect/switch based on expected churn probability (obtained by data from similar demographics (in terms of demographics as well as food demographics) of customers who are no longer visiting the store). The system may mark the type promotions in transactions because these data may further be used to evaluate the strategies used to keep the customer's interest with the store. Also, an eco-friendly digital receipt can be utilized to reduce paper consumption (by directly and securely electronically sending the digital receipt to customer's smart phone or some other place (such as an offsite vault in the cloud). Thereafter, the customer could sign the digital receipt and securely send it back to the POS.
B. Using the customer's location information, it is possible to schedule the order processing just in time based on the customer's expected arrival time. The worker may be monitored so that he/she can prepare the order in time for the customer to pick up. When the delay in preparation is abnormal, it may signify productivity problems or abnormality of special orders. It is noted that the customer may opt in to have his/her location information tracked. In such a case, the customer's location data can be sampled at certain intervals or landmarks (instead of precise location at each time unit).
C. When a customer enters the store it is important to monitor the service level provided by the workers to the customer. A video analysis subsystem may capture data that can be correlated to the meet-and-greet behavior of a sales person or how a cashier handles returned goods. Abnormally high or low correlation or occurrence may signify sales or loss prevention opportunities.
D. Face detection and recognition to determine a worker's time and attendance (recorder has logs of video) or to determine a customer self-service sequence abnormality may notify worker to provide customer support on demand basis automatically. The worker's mobile phone may be used as an access control card with face verification to increase the system reliability.
E. Digital signage (response to customer profile, age, race, etc. as input to ad manager to match the ad content with majority customer profile). When encounter abnormal profile, system can raise the alert level to the workers. An integrated POS system and digital signage provides a solution. The cameras on POS terminal faces to the customer and capture the face image of customer (selects the best set of face images for further processing and recognition tasks). The collected face images are supplied to an age, gender, etc. decision module to get customer profile information. This information is used by profile based advertisement system to control the content on digital signage. The same recognition system is also utilized for security and safety applications (in case of search of person of interest). Optionally, the security application requirements of the system may be separated from other applications (marketing, operations, promotions, staffing, merchandising, loyalty programs, etc.) in order to comply with applicable privacy regulations which may regulate, e.g., the kind of information that can be collected and duration of information retention. In this regard, personalization functions can be performed without ‘identification’ for customers who opt out of letting the system use their personal information.

A feature of the disclosure tracks traffic data in addition to or as an alternative to tracking POS data. While POS data is used to track historical sales, transactions and inventory movement, traffic data is the ideal metric for understanding sales potential. Since the traffic data set is larger than the POS data set (since not all people who enter a store make a purchase), analyzing traffic data presents a site with an opportunity-based sales strategy. For example, if a store can deploy the right people in the right place at the right time, then it meets customer demand and expectations without incurring additional personnel costs (i.e., the system allows a store to maximize the utility of its staff). A further feature of the disclosure uses this traffic data to determine site revenue (or profit) per square foot, in order for the system to determine optimal site floor configuration (e.g., site size and/or floor plan).

Another feature of the disclosure allows a site to detect an unassisted customer. In such a situation, it is desirous to ensure that the customer is quickly assisted in order to avoid a potential loss of sale. In this regard, each sales staff member holds a location-identifying device (such as, for example, a mobile POS, RFID tag, tablet PC, mobile PC, pager, smartphone, and the like), and the identity and location of customer waiting is identified (using, e.g. face recognition, CRM, smartphone). Note that the actual identity (name, etc.) is not required for the system to work, only that a unique individual is identified (e.g., Asian male, aged 18-35).

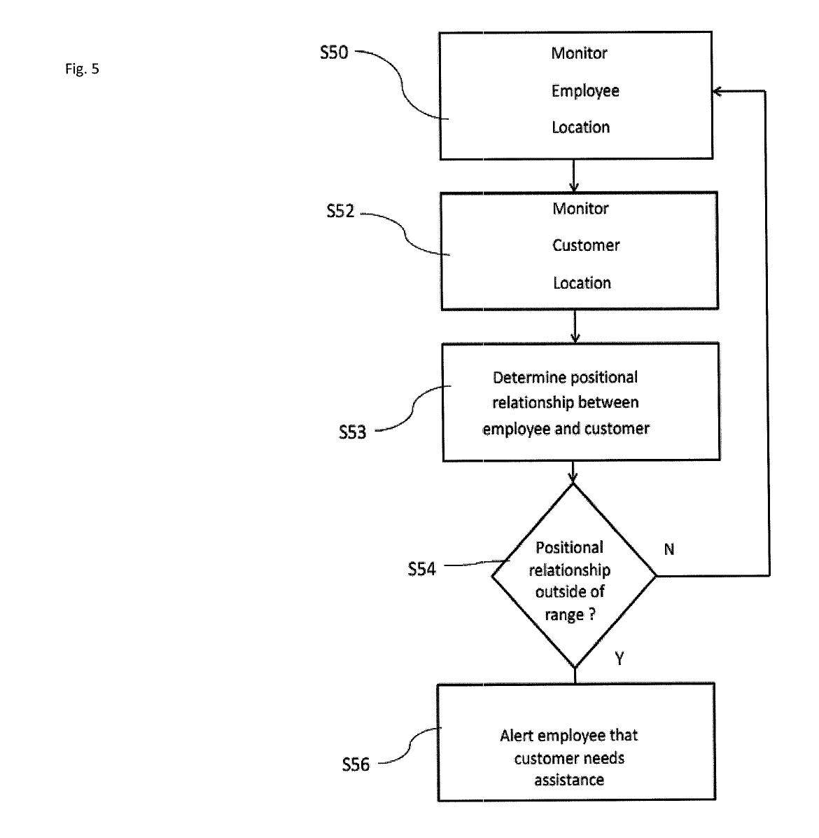

Referring to FIG. 5, at step S50 the location of an (preferably idle) employee is monitored, and at step S52 the location of a customer is monitored. Using the location identity as described above, at step S53 the positional relationship between the employee and customer is determined. At step S54, if the distance between the employee and the customer is outside of a predetermined value range, at step S56 the employee is alerted that the customer needs assistance. If at step S54 if the distance between the employee and the customer is within a predetermined value range, then the system determines that the customer is being assisted by the employee, and the processing returns to step S50. The system also has the ability to track and record how long it took for the employee to greet the customer, as well as to determine the originating location of the employee at time of dispatch. It is noted that while using tracking technologies to determine the location of the worker/staff member is generally acceptable, some customers may object to having their location tracked. In this regard, the system allows the customer to opt in or opt out of having their location tracked and/or determined. In the event that the customer opts out of having his/her location precisely tracked as described above, the system can utilize video and/or wireless technologies to determine the presence/existence of customer at a coarse location (for example, a given aisle), as opposed to a precise location (accurate within ±3 feet).

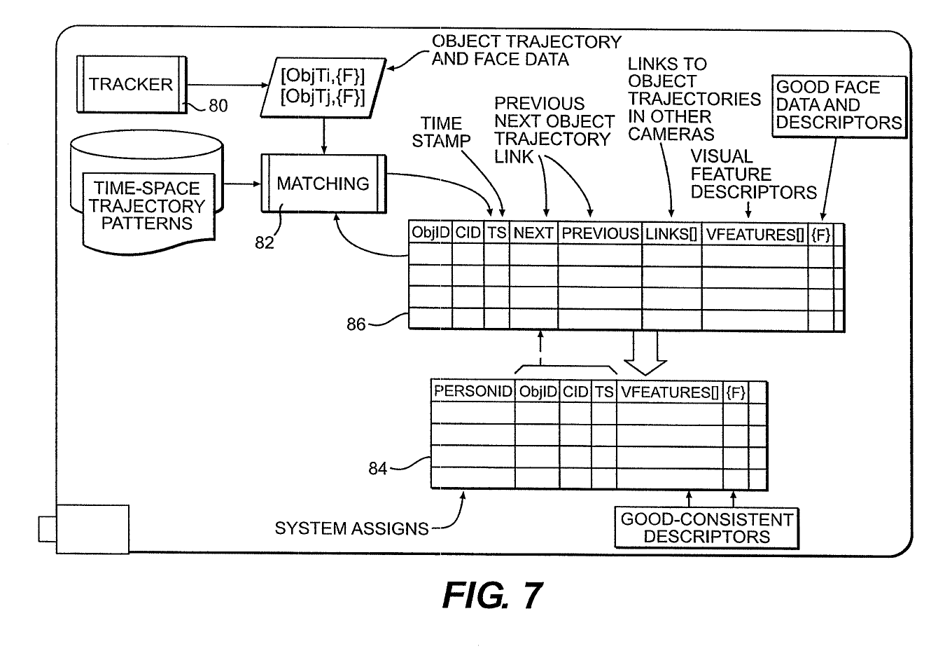

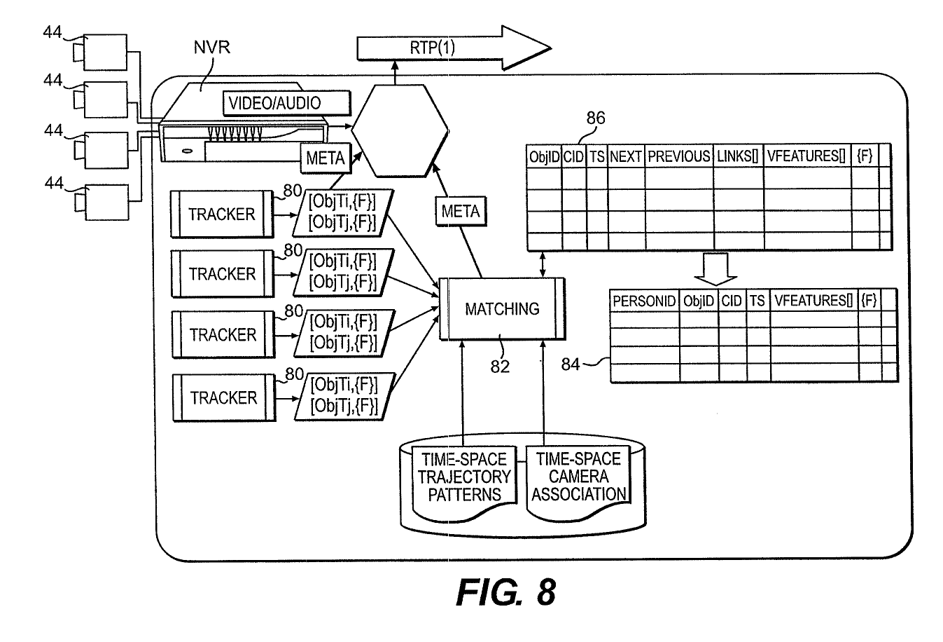

Referring to FIGS. 7-8, a feature of the disclosure also uses face detection and matching to obtain customer information such as customer arrival information. To increase the accuracy of customer tracking, the system uses a set of face data {F} associated with each tracked object trajectory ObjTi, ObjTj as additional features. The objects are first captured by a sensor (such as a camera 44) connected to or having an object tracker 80. Tracked objects are processed through matching module 82 which determines the similarity between object trajectories by using their movement pattern and set of face features. The matching module 82 identifies a similar set of object trajectories, and considers them to belong to the same person. Note that the actual identity (name, etc.) is not required for the system to work, only that a unique individual is identified.

Furthermore, the matching module 82 processes the object trajectory data ObjTi, ObjTj coming from different cameras for real time similarity search to recover the object trajectories belonging to the same person by utilizing the set of face data/feature associated with object trajectory data. Also, object trajectory data could be used for multi-camera calibration purpose.

Also, to speed up the tracking process, the matching module 82 can prune the candidates based on learned time-space associations between cameras. After the above trajectory grouping is accomplished, the system can update the appeared and disappeared time stamp of a person to determine, e.g., which customer was first, how long customer has been waiting, how long customer has been in the store (possibly displayed on monitor) by using persons table 84. Such information can be used, e.g., to determine which queue to offload, to determine cashier performance. Again, note that the actual identity (name, etc.) is not required for the system to work, only that a unique individual is identified.

The system is also able to judge whether an obtained facial image is of good quality, can judge whether a set of representative facial images is of good quality, can calculate the similarity between one face and set of representative faces (and can be camera aware).

FIG. 7 demonstrates how the object trajectories in the same camera view can be associated by using set of face data and face features. In FIG. 7, the tracker 80 can also extract the face detection and determination of whether an obtained facial image is of good quality; however, not all object trajectories will have face data (e.g., in situations when a camera is observing an individual from behind).

When the matching of trajectories is completed in object table 86, these matching trajectories are mapped to person view in which system can assign a unique identifier and extract the person arrival time, using persons table 84.

Cashier performance may thus be evaluated by combining the queue time information, how many customers balked (left the store without making a purchase), number of POS transactions, items, and amount, and the like. In the case of multiple cashiers, then the store manager could immediately see the average customer waiting time for each cashier. The measurement of loss opportunity is often important for the store to make proper forecasts of expected customer traffic. From the POS alone, a store can only know who was patient enough to wait and then pay for merchandise; however, according to a feature of the disclosure, the aforementioned collected information may be converted to performance metrics for each cashier. Then, video recordings of high-performing cashiers can be utilized for training other cashiers, e.g., to show other cashiers how to efficiently handle busy periods.

FIG. 8 shows a system for face detection and matching using multiple cameras 44. When using multiple cameras 44, matching module 82 uses the camera specific trajectory patterns together with camera-association patterns to reduce matching execution time by pruning impossible cases. The persons table 84 is populated in the same way as described above.

The customer (object) waiting the longest is the one with the minimum timestamp. This information can be inserted into camera video streams along with the tracker metadata “Meta.” The customer waiting time or the amount of time the customer has been in the store may be displayed when the metadata of object is displayed, using for example, a Real-time Transport Protocol RTP. In this way, the profile of an average shopper's average shopping time could be utilized to provide an alert to monitoring personnel that a specific object/person is in the store for longer than average, which could be a pre-screening for loss prevention. This information may be stored in a Network Video Storage (NVR).

In a situation where there is no idle employee to assist the customer, the system uses a revenue expectancy model to assist the customer. For example, if there is an unassisted customer holding a high-value item such as, e.g., a computer (determined by, e.g., an RFD tag on the item) or lingering in a high value location of the store (e.g., the computer aisle), and there is another customer being assisted holding a lower value item (e.g., a video game cartridge) or lingering in a low-value aisle of the store (e.g., the video game aisle), then the employee assisting the customer holding a lower value item or lingering in a low-value aisle of the store is directed to leave that customer to assist the customer holding the high-value item or lingering in a high value location of the store. In this way the customer with the greater revenue expectancy is prioritized. The system also can store the sales and education skill set of each sales associate, which can then be matched with type of merchandise. The system can utilize the skill set information to select a sales associate (out of multiple idle sales staff, out of multiple busy sales staff) to dispatch to the area of the store stocking the appropriate type of merchandise.

A further feature of the disclosure monitors the location of a plurality of customers, and determines the period of time each customer not being assisted has been unassisted, whereupon sales staff may be dispatched to the customers in order of which customer has been waiting the longest.

Another feature of the disclosure provides a system and method for deciding appropriate customer waiting time depending on the type of merchandise. In a store, each aisle/section carries a different type of merchandise, and customers spend different amounts of time depending on the type of merchandise in the aisle/section, and will accordingly often look for sales assistance.

As described above, the system is able to use video data mining techniques to detect and/or predict the expected wait time of a customer. The system utilizes the RFID tracking (staff and merchandize) and video (customer, staff, merchandize) to provide the functions. When the system detects that a customer stayed longer than expected, the system dispatches a sales associate. The collected transaction data records the aisle the customer waited, how long he/she waited, when the sales associate arrived, sale associate ID, how long sales associate assisted the customer, whether the assistance resulted in sales, and amount. The system records when customer left without any sales associates having assisted him/her (loss opportunity). A conversion rate (the rate based on whether or not the assistance to the customer resulted in a sale) is calculated as to whether or not the purchase occurred (using, e.g., RFID tag data). The system can then adjust the customer stay threshold depending in the observed conversion rate success. A further feature of the disclosure may provide “help” buttons in store aisles, which can be utilized to judge when customers reach out for help. A combination of video based data, lingering time, and when the “help” button pressed is processed by system, and this information may be utilized to pre-dispatch an associate to strike a balance between giving the customer an adequate amount of time to browse and being on time to offer assistance, thereby resulting in less frustration and anxiety on the part of the customer side, and provide a better shopping experience. The system can also generate aisle-specific such expectancy models, and can generate aisle and customer demographic specific expectancy models when the ‘demographics’ of the customer is also available. Other video based technologies could be utilized by the system when appropriate, such as remote emotion identification by using object gait, face, etc. to extract further data about the customer (e.g., whether relaxed, happy/smiling, anxiety level high, agitated, puzzled, paces back and forth, etc.). Such data could be used to identify aisles which gives the most anxiety/frustration to our customers as well as the “happy aisles” where customers spend less time with lots of picked up goods.

The captured video (which leads to conversion) can be utilized for training of other associates. Assets such as this allow human resource departments to train and re-train their sales associates with captured and missed opportunities.

After the POS transaction data is collected per store, the system can aggregate the data of time periods together with weather information and holiday information. This aggregation produces the basic models for predicting the sales, sales items, and demand for staff. After the individual store data is collected in a centralized data warehouse, another algorithm aggregates them by geographic location of stores, thereby providing the geographical similarity and dissimilarity models. This measure can be used to detect abnormal store performance in which the high performing stores help headquarters learn more about which sales and/or marketing techniques are working, so that low performing stores are either put on a program or closed. A further feature of the disclosure allows for the comparison of ‘floor plan’ testing (or any other market testing), which can be easily realized by:
1) picking similar stores (based on their profiles (data associated with a store such as sales, items, customer demographics, floor, sales associates, etc.)
2) Comparing two or more sets of floor plans, promotions, or whatever sets the user wishes to compare, and
3) Collecting the data for a predetermined amount of time to check whether there is any difference/efficiency gained by the proposed change.

Using the above, the system in accordance with a non-limiting feature of the disclosure allows headquarters to run very disciplined comparable improvement tests and see the comparative results in real-time, daily or hourly.

The determination of expected sale items will allow delivery of goods to individual stores, and an aggregate view can be utilized to optimize the delivery of goods to various sites. Supply trucks can be packed with the goods for multiple store locations, thereby improving the supply delivery as well as inventory on each individual store where each store will have the goods that sell the most until the arrival of next supply truck. Using this data, the system can compare the cost of being out-of-stock and the cost of dispatching a supply truck. This constant information collection, aggregation, prediction, and turning into various business actions will increase the efficiency of site operations.

According to another feature of the disclosure, integrated car (or smartphone) navigation systems and customer ordering systems can give actual driving distance to nearest reachable shop. Furthermore, the integrated system can combine the real time traffic congestion data with historical data to come up with a new definitions of “nearest shop” which depends on the time of day, roads, road work, customer's current location, customer's order, shop working hours, etc. For example, the current location of a customer may be the same for day one and day two, but the “nearest store” data returned to the user differs from day one to day two due to, e.g., scheduled road repairs or a road closure/blockage (due to, e.g., a visiting dignitary) for day two.

When the order is passed from one station to another (during the order fulfillment process for example in warehouse, which has pick, pack, ship, steps and the like), cameras can get snapshots of the order during this pipeline to record or journal how the order is fulfilled by the system. Loss prevention personnel can investigate loss or complaint cases by accessing the journal which explains how the particular order has been filled. In practice, this operation can be realized by efficient integration of multiple technologies. For example, tracking, order processing, cameras, and control module which knows the location and FOV (field-of-view) of cameras, processed orders, instructs the cameras to prepare to capture images and store them in a multimedia server. The controller may preconfigure each camera with an action which is triggered by a tag read event and matched with the expected tag number (which is associated with the order). The controller may preconfigure all the cameras which may capture the image of the order in response to tag read events. Also, each action also includes instructions as to where to store the captured multimedia information. Furthermore, controller also configures an action which is triggered if the expected tag read event is not observed within a given time window to detect if the order did not show up at the expected location. Additionally, the time window is learned based on the prior data collected from similar/same orders. Still further, if the expected read did not happen, such event can raise an exception/abnormality alarm to direct the manager's attention to investigate and fix the problem. In such case, the system may initiate a UC communication between manager and the worker while notifying the manager.

In the case of retail POS transactions, loss prevention (LP) personnel investigate certain operations, such as cash transactions, returns above certain price threshold or certain items of interest (based on, e.g., SKU number), transactions with coupons or discounts, payment segment, certain credit card type, certain cashier, etc. It is beneficial for the LP personnel to be able to pinpoint the “segment” of multimedia (video, audio, face, etc.) record containing the pertinent part. Giving the LP personnel the necessary multimedia segments enables the LP personnel to do their job more efficiently.

### Location-Aware Order Handling

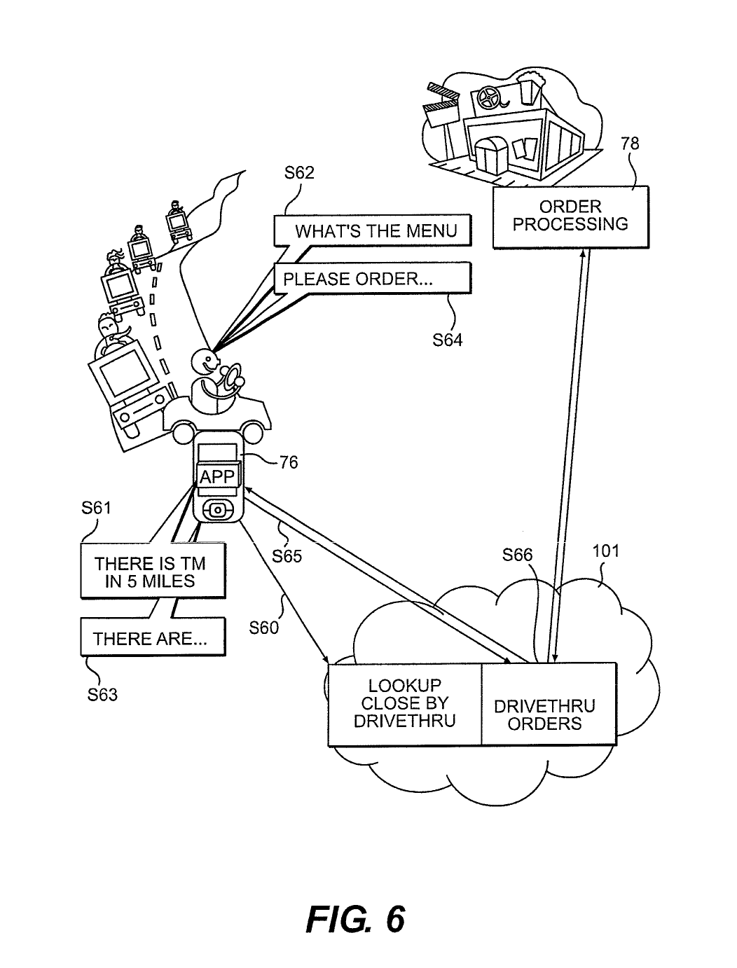

An aspect of the disclosure provides location aware order handling for sites such as fast food drive-thru operations or any other site which accepts pre-ordering for later pickup, as shown in FIG. 6. A location-aware order application may run on, for example, customer's wireless device such as, e.g., a cell phone 76 or other mobile device. This application is connected to network 101 using a service to locate nearby drive-thru sites based on customer location, performed at step S60. At step S61, the application notifies (by audio alert or otherwise) the customer (while he/she is driving or otherwise moving) about the nearby stores. At step S62 the customer selects one of the nearby stores and inquires as to the menu of available items at that store. At step S63 the application informs the customer of the available items. If the customer wants to place an order, the application takes the order (using, e.g., a speech interface so as not to distract a customer who is driving) at step S64. After the application verifies the order with the customer at step S65, the application submits the order to the store at step S66 and obtains a code for pick up. The application may also provide navigation instructions to the customer. The customer pulls in to the site, informs the site of the code (by e.g., showing the ticket on the cell phone screen), and picks up the order. This solution automates the order taking and payment steps. The payment may be taken by the site when the customer arrives, or may be done electronically by cell phone 76.

Thus, labor and transaction time and expenses may be reduced, transaction time may be reduced, LP opportunities may be reduced due to automated payment collection, consumer waiting time may be reduced, and per store profit and revenue may be increased by serving more customers due to reduced congestion.

To further increase efficiency of the store/site, orders may be scheduled and prepared based on estimated arrival time of the customer. For example, after the system accepts the order through the cell phone 76 from the customer, the system estimates the arrival time by receiving customer location.

information from the in-car or cell phone 76 navigation system and informs order processing system 78 (which may be cloud-based or at the location of the pickup site) which in turn combines the arrival time information with the estimated order preparation time to determine when to schedule the preparation of the customer's order. By preparing just-in-time orders, the customer receives the food (or other item) freshly prepared, thereby improving the customer's satisfaction. Further, the kitchen at the store is then enabled to prepare the food more efficiently.

In an aspect of the disclosure, the order processing system 78 may also send the customer a facial image of the worker who will prepare and/or provide the customer with the order. When the customer arrives to the drive thru, the customer shows the facial image of worker to a face recognition system, which informs the worker about the pick-up of the customer's order through a notification system (such as a pager, voice communication system, and the like). The order processing system 78 sends a code (such as a quick response “QR” code and the like) that is associated with the order and payment. When the customer arrives to the drive thru, the customer shows the code (which may be an image on wireless device/phone 76) to an order code recognition system that informs the worker of the arrival of customer for order pickup.

Also, using a customer count based on demographics (age, sex, race, etc.), the work force management system can match the work force with the demographics of expected customer traffic, thus improving customer care and experience.

### Customer Verification

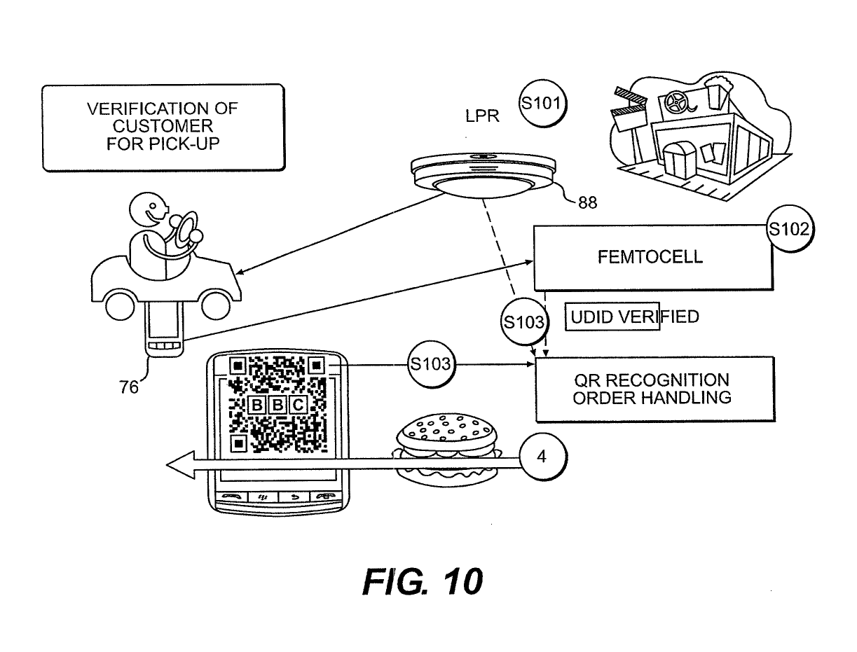

Referring now to FIGS. 9-10, when the customer comes to pick up his/her order from a site such as a drive-thru establishment, the system is able to verify the identity of the customer, i.e., that the customer who placed the order is the same customer who is picking up the order.

When the customer places the order, data including an image of the customer's face may be provided to the system (either from the customer's smartphone, pre-stored through the CRM, etc.), so that the store employee can easily identify the customer by matching the face image attached to the order by looking at the face of customer. Alternatively, instead of a store employee visually confirming the matching of the customer's face, a face detection and recognition system may be utilized to compare the face of the customer picking up the order with the image of the ordering customer's face. To increase operational efficiency, in the event that the face recognition system cannot verify the identity of the customer picking up the order, the face recognition system can alert the worker that the worker needs to further verify the face of customer. Using a graphical user interface (GUI), the worker can wear enhanced eye glasses which can show the face image of expected person who will pick up the order.

The order making process is revised and the order handling service also returns an order code (including but not limited to a QR code) which customer will show to pick up the order. The QR code sent to the customer includes encoded information obtained from, e.g., customer name, unique device identifier (UDID) of a mobile device, mobile phone number, CRM member number, license plate, order number, etc. This code is also provided to the site.

FIG. 10 schematically shows an exemplary manner in which a customer is identified after receiving the order code. When the customer arrives at the establishment in his/her vehicle, in Step S101 a license plate reader 88 collects the customer's license plate information. In step S102, a wireless protocol system, such as a femtocell, collect the customer's UDID information from his/her smartphone 76 (for example, the femtocell validates the order processing system to accept registration from device or members database), such that the system accumulates data about the customer by using his/her license plate and mobile device UDID.

At Step S103 the customer shows the QR code on her mobile phone, whereupon a QR recognition module detects the code, extracts, and decodes the code. The QR recognition module checks the information against the ordered items, information collected by the LPR and wireless protocol system in the order handling system. Since two or more items of (or alternatively all) information is required for an acceptable match, the system can verify that the customer picking up the order is the customer who ordered.

The aforementioned system can be enhanced in terms of how the QR code is encoded (i.e., it may be encrypted by using a key derived from UDID, face image, etc.). In alternative embodiments, the system can check the location of phone (by GPS or other geolocation) or social media sites (if member's information is known).

The aforementioned system can determine the arrival rate of the customer. For example, a camera 44 or other sensor observes the entrance of the drive thru and detects whether a car entered the drive thru lane. The system then collects these “enter” events and produces per-hour arrival count data. The arrival rate for any given hour is calculated by taking the mean of count samples of the same time interval.

The aforementioned system can also detect a rate of customer arrival that is abnormally higher than expected, by using the continuously learned models and current observations. The system can generate a report or alarm when the number of arrivals within the last service time (moving window) with respect to the expected/learned arrival rate for the current time interval and last alarm time stamp.

The aforementioned system can further detect a rate of customer arrival that is abnormally less than expected, by generates a report or alarm based on the prior learned models and the current observations. The system can periodically check the last arrival events against the expected inter arrival time for the current time interval. If the distance in the time dimension grows larger than expected with respect to the learned inter-arrival time for the current time stamp and the last alarm time stamp is more than the expected inter arrival time, then the method generates an alarm or report to inform the situation.

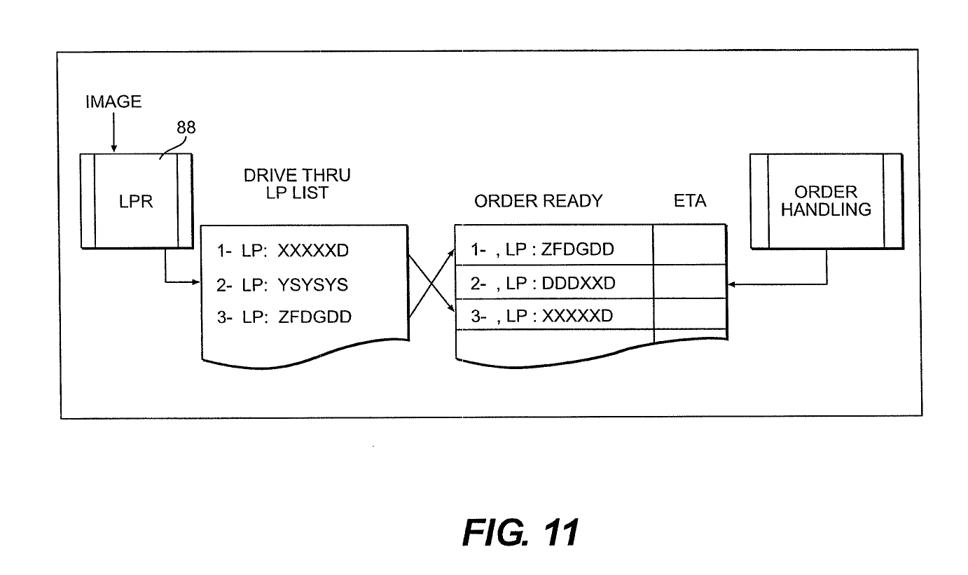

The aforementioned system can additionally arrange the sequence of customer orders based on the customer sequence of arrival, as shown in FIG. 11. The license plate reader (LPR) 88, which reads the license plates of the vehicles as they arrive at the site, generate a drive-thru license plate list (LP) of vehicles in the order of vehicle arrival. The order handling system references an Order Ready list of ready customer orders and arranges these orders to correspond to the drive-thru license list, so that the orders may more easily be delivered to customers in the sequence they arrive at the pickup window.

### Loss Prevention (LP)

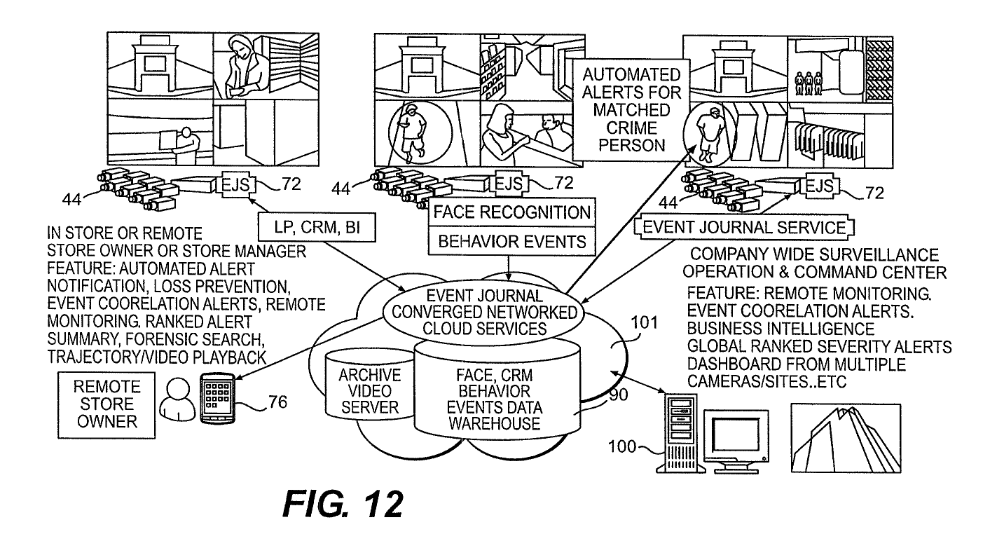

An aspect of the present disclosure assists in avoiding loss prevention by linking loss prevention/store security videos (which may be from multiple stores) in an automated multimedia event server to discover their affinities, to help identification of organized theft rings. LP cases are ranked based on their content similarity. LP personnel can investigate the LP videos and validate their linkage (which increases the linkage between LP videos for browsing them with Event Multimedia Journal 72). Linked browsing enhances the effectiveness of LP personnel by reducing the number of videos to be investigated and focusing LP personnel to a less lengthy, more relevant set of videos. LP personnel can thus more easily remember the similarities of video contents, thereby reducing investigation costs while improving system efficiency by sorting and linking LP multimedia data. FIG. 12 shows an exemplary linked loss prevention system in accordance with a feature of the disclosure using a cloud service.

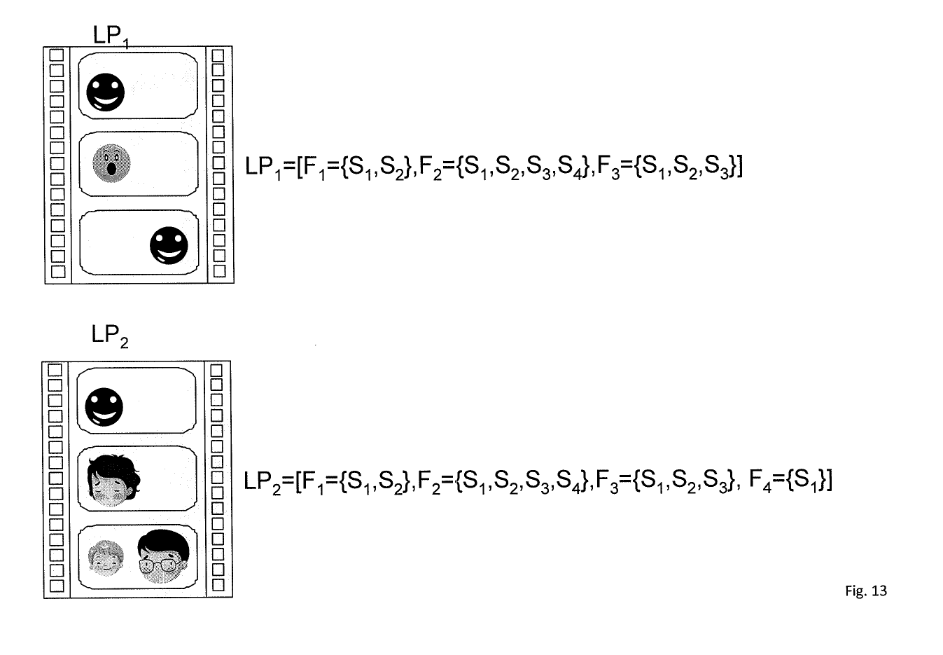

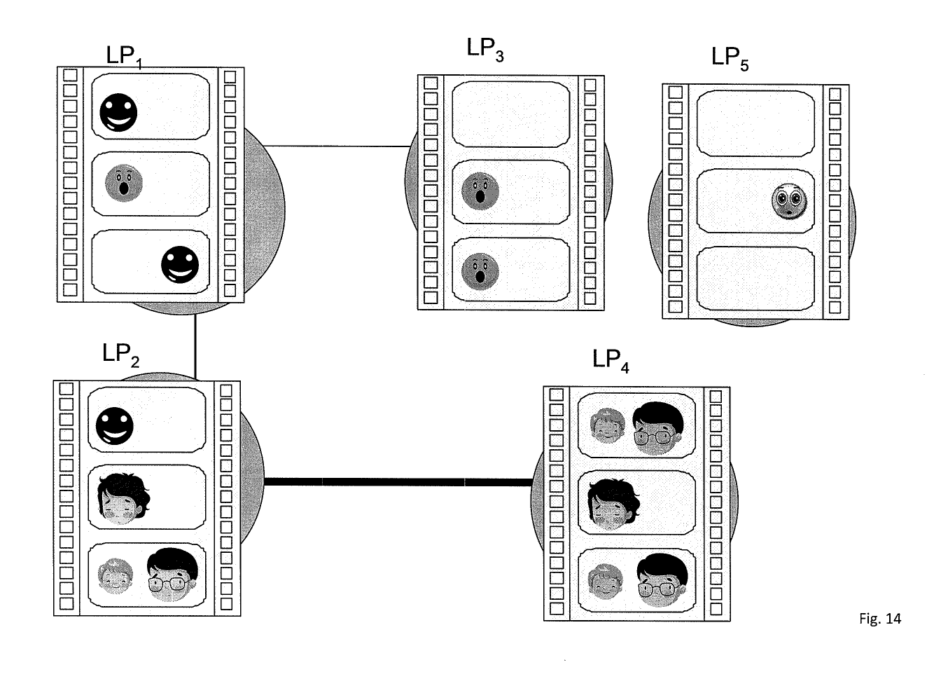

A feature of the disclosure uses sets of face data for correlating between LP cases, as shown in FIGS. 13-14. The set of face features are present in the LP video in the form of metadata, and is used to judge content similarity between LP(i) and LP(j). LP server 90 contains [LPi,FVi] tuples where FVi contains the metadata of LP(i) (FV being defined as face feature vector). The FV(i) may have different number of metadata features (due to the number of detected faces, POS items, etc.).

In FIGS. 13 and 14, LP₁={{ }, { }, {,}, . . . } and LP₂={{ }, { }, { }, . . . } each has set of faces for each of the detected objects. LP₁∩LP₂ indicates the common people in both LP cases. A score-of (LP₁∩LP₂) can be used to rank LP cases. Higher correlation means that correlated LP cases are related. D(LP₁, LP₂) denotes content similarity. The score function can have additional information from mined results about the accuracy of a particular observed area (e.g., samples obtained in particular time interval and particular area/region in camera field of view (FOV)), as defined by: Accuracy(TimeInterval,AreaOfCamera,CameraId) ε [0, . . . , 100].

Further, when pan-tilt-zoom (PTZ) is used, the home position information becomes a part of Accuracy function (i.e., the PTZ coordinate information should be also considered), as defined by Accuracy(TimeInterval,AreaOfCamera,CameraId,PTZ) ε [0, . . . , 100]. Face detection accuracy depends on the view of camera and in PTZ, the “home” position is one way to specify the view. The home position of PTZ also becomes important when linking object trajectories between cameras since the linkage between viewpoints of cameras (static and PTZ) is affected by the view of PTZ cameras. This information is carried in video stream metadata.

It is also noted that to increase accuracy, in addition to the metadata containing the face features, the metadata may additionally contain, e.g., POS transaction data, cahier information and the like may also be associated with the video images.

According to another aspect, each LPi is modeled as a node of a graph and an algorithm can assign a strength value to the link, connecting LP₁ to LP₂, as a function of LP₁∩LP₂. Then, a ranking algorithm can select the group of LP cases with strong connections (islands in the graph) due to strength of connectivity of LP videos.

FIG. 8 shows groupings of LP videos linked based on the score of LPᵢ∩LPⱼ, whereby the system can extract a common set of people (who are, e.g., responsible for the LP incidents). The cost of linking videos may be kept down by using the system running on an on-demand scalable cloud platform. The user can utilize such a service when necessary (which could be tied to the number of LP incidents and triggering this service when it goes beyond the expected incident level). The triggering service selects the LP cases by utilizing their time and location affinity to reduce the computation time. Also, a face resolution enhancement module can utilize many parts of available face images to obtain a higher resolution face image (e.g., by super-resolution techniques) or 3D re-constructed face image.

In addition to or as an alternative for recognizing face data to prevent theft, the system has the ability to record and store loss prevention sub-event data as a composite event, as it relates to retail theft, and create real-time alerts when a retail theft is in progress. For example, if a certain retail theft ring has a standard modus operandi for each retail theft event, such as the following sequence: 1) Person A distracts a clerk in the rear of the store; 2) Person B pretends to have a medical emergency by falling on the floor; and 3) Person C grabs cigarettes and runs out of the store, data (including multimedia and metadata) related these sub-events are stored by the system and identifying as corresponding to a certain retail theft ring. Subsequently, when sequences 1 and 2 begin and are identified by the in-store sensors 42, 44, 46, 48, 50, the system alerts management as to a possible retail theft in progress, thereby giving the manager time to intervene.

An aspect of the loss prevention system described above may use face features to validate returns in order to minimize return frauds. Also, in case of loyalty programs handled by CRM system, there could be many face features associated with the customer account.

Once the customer makes a purchase, a camera near the POS captures an image of the customer's face, and face detection and feature extraction is subsequently performed. Thereafter, the transaction is stored with the extracted face features. When a customer visits the store to return an item, a camera near the POS captures an image of the face of the customer returning the item, whereupon the face features of the customer returning the item are validated against the stored face features of the customer who purchased the item, in addition to the POS transaction items. The return transaction is evaluated for fraud based at least in part on whether the face features of the customer returning the item match the face features of the customer who purchased the item. This at least gives cashier an opportunity to validate who purchased the return item and evaluate the customer's answer.

The system may be used for multiple applications, such as in a situation where the item is purchases from store A but the item is returned to store B, by using a centralized or peer-to-peer architecture for authentication and authorization of return.

POS-face detection and feature extraction may be followed by verification against the credentials obtained from customer's credit card or other customer-associated account (which could contain biometrics data or service address for authentication of biometrics data).

Also, the return multimedia record can include the face of both customer and cashier in the case that the POS has face detecting cameras on both sides of terminal. The cashier-facing camera can become a deterrent for employee theft, since cashiers will know that the POS transactions will include video images which can include their face, and that these video images can be used by the system for emotion analysis to further automatically annotate these videos for further analysis.

The return multimedia record can include the emotional classification of customer and cashier from their visual and audio/speech data, in order to provide the appropriate level of customer service.

The system can check whether the customer returning the item was in the store before coming to the return desk (generally the item return or customer service counters are at the entrance, and the expected behavior is that the customer returning the item comes directly to the item return counter. Although, this assumption can be verified when data is collected and analyzed to see whether this assumption is correct or not. The fact that the customer returning the item was walking around the store could be indicative that the customer picked up the item at that time and is trying to fraudulently return it.

Alternatively, the POS-face detection and feature extraction may be used by the customer in lieu of a receipt, e.g., in the event that the customer returning the item cannot find the receipt, the system can retrieve the customer information associating his/her face with the prior purchase of the item, thereby enhancing the customer's shopping experience.

### Queue Management

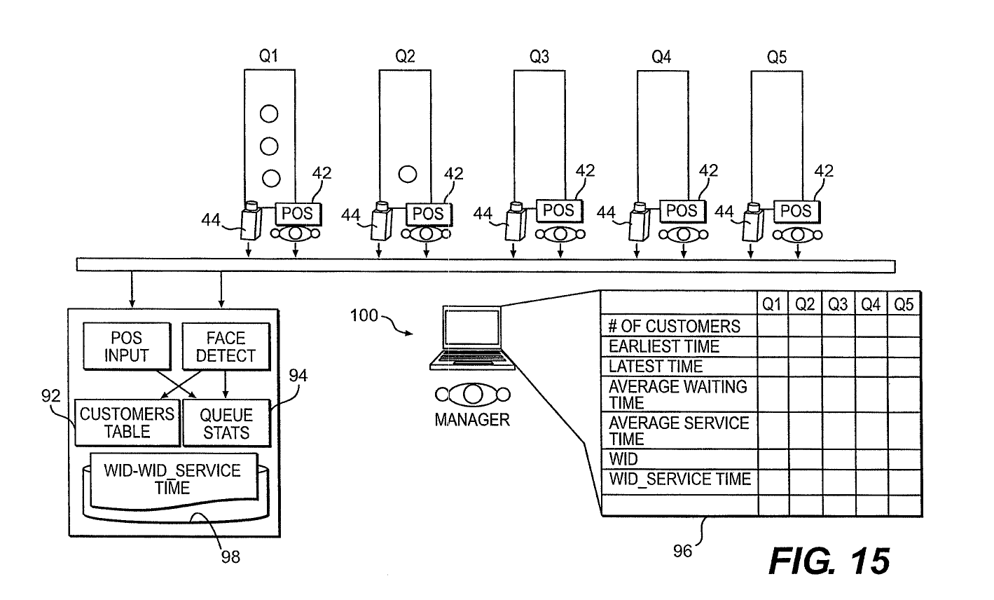

Referring to FIG. 15, an aspect of the disclosure also provides a system of store management by using face detection and matching for queue management purposes to improve site/store operations. FIG. 15 shows a schematic view of the system, store manager display 96, and queues Q1-Q5, wherein customers are represented by circles. The system uses the above-described system to detect a face, extract a face feature vector, and transmit face data to a customer table module 92 and a queue statistics module 94. The system is able to collect and send POS interaction data and face data to the queue statistics module 94. The customer table module 92 judges whether the received face is already in the customer table. The queue statistics module 94 annotates video frame with POS events/data and face data (which may be part of metadata), obtains the customer arrival time to queue from a customer table module, obtains cashier performance data (WID, WID_ServiceTime) from a knowledge base 98, inserts cashier performance for each completed POS transaction to a data warehouse, assesses the average customer waiting time for each queue, and sends real-time queue status information to the store manager display 96.

The store manager display 96 shows real-time queue performance statistics and visual alerts to indicate an increased load on a queue Q1-Q5 based on the real-time queue status and the cashier's expected work performance data (WID, WID_ServiceTime). The store manager display 96 can also communicate each queue status to the manager by visual and/or audio rendering.

The aforementioned system is able to select a good-quality face feature to reduce the amount of data to be transferred, while increasing the matching accuracy. Also, the customer table module 92 selects a set of good face representatives to reduce the required storage and increase matching accuracy. Further, annotated video frame data may be saved in an automated multimedia event server 72, linked by their content similarity by the automated multimedia event server, accessed by the store manager display 96 from the automated multimedia event server to browse the linked video footage to extract the location of the customer prior to entering to the queue. With this information, the store manager can decide whether to move a customer to another queue, open a new queue, or close the queue.

### Personalized Marketing

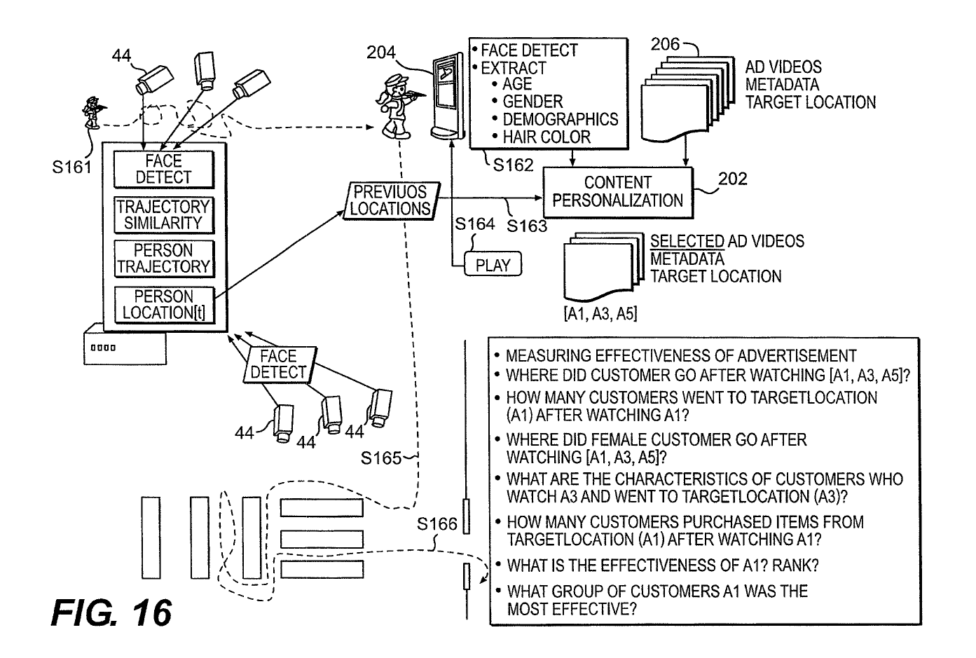

FIG. 16 shows a system for personalized advertisement and marketing effectiveness by matching object trajectories by face set. This system uses the multi-camera face detection and matching system described above to personalize advertisements (such as on an in-store marketing videos), to track the effectiveness of such personalized advertisements by following the subject's behavior after the campaign.

At Step S161 the customer enters the site or store, whereupon at step S162 her identity is detected using the multi-camera face detection and matching system described above. Note that the actual identity of the person (name, etc.) is not required for the system to work, only that a unique individual is identified and tracked throughout the store. Alternatively or additionally, the customer may “check-in” using a wireless device such as a smartphone 76 (via geolocation or other wireless system) or store kiosk, whereupon the actual identity of the person is obtained. Once the identity (actual or not) of the customer is detected, identity characteristics are extracted, such as age, gender, demographics, hair color, body type, etc. At step S163 ad content personalization agent 202 uses the extracted identity characteristics to determine custom/personalized ad content. Once the ad content is determined, one or more advertisements A1, A3, A5 are sent to the customer via either an in-store display 204 or the customer's wireless device for viewing by the customer at step S164. These displayed ads are stored in a database for later retrieval. Preferably, steps S161-S163 occur before step S164. It is also noted that the determined custom ad may be retrieved from a series of pre-made ads 206, or a unique ad may be prepared on a just-in-time basis (which may also include, e.g. a user's name and/or face) to create a unique shopping experience. Also, the displayed ad(s) may route the customer to an area of the store.

After viewing the custom ad, at step S165 the customer is tracked throughout the store using video cameras 44 or other sensors (e.g., sensors for tracking the signal of the user's wireless device), wherein the areas of the store visited by the customer are detected and stored, including data related to how long the customer lingered in each area, whether the customer asked for assistance, and the like. After the customer leaves the store, at step S166 it is determined whether or not the customer made any purchases, and if so, whether those items purchased were communicated to the customer in the ad. This information is then stored for future reference and analysis. For example, based on the areas of the store visited by the customer, a different set of ads may be displayed to the customer upon the customer's next visit to the store.

With this information, aggregated analysis of the store customer traffic is utilized to rank to ad content effectiveness by measuring, e.g., where the customers went after watching the ad, the number of customers who watched the ad content, how many customers went to the targeted location in the ad after watching the ad, the demographics of the customers who went to the targeted location in the ad after watching the ad, the average time spent by the customer in the targeted location, how many customers who saw a given ad purchased the targeted item. In this way the effectiveness of the ads presented to customers may be determined, including the effectiveness of the ads with respect to each customer demographic. It is also noted that the present system may be used across multiple stores, including event management with a networked/cloud service.

As an example of the system for personalized advertisement and marketing effectiveness, if a shopper identified in a store is shown advertisements for shoes and baby clothes, but only visits and makes a purchase from the shoe department, then the system may log the shoe ad as a success and the baby clothes ad as a failure, whereupon store management may decide on a different type of marketing campaign for the customer's demographic or overall. If this customer visits the baby clothes department and spends a significant amount of time in the store without making a purchase, then perhaps the type and/or placement of merchandise may need to be evaluated by store management. Also in such a situation, upon leaving the store, the customer may be presented with additional ads, or some type of incentive (such as a coupon, discount code, etc.) based on the areas of the store the customer visited or didn't visit the expected target areas.

### Multimedia Event Journal

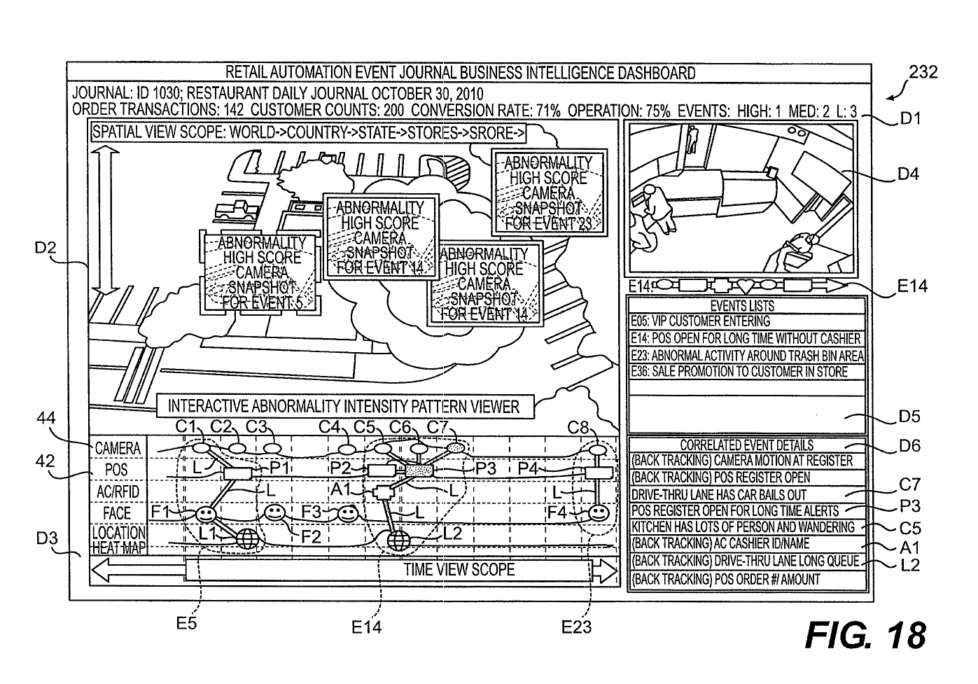

Referring to FIG. 17 (which is a variation of FIGS. 2-3), an aspect of the disclosure also provides an automated multimedia event journal server (EJS) 230, which may be used with any of the above-described features, which automates the creation of application-specific recorded multimedia annotation via event sensor sources, including but not limited to POS 44, video 44, unified communication (UC) 46, site access control 48 and facility/eco control 50, CRM 210, sound recorder 212, biometric sensor 214, location sensor 216 and the like. The EJS 230 provides similar functionality (e.g., event sequence mining) of the ADS; however, the EJS also provides a multimedia event journal displayable as a business intelligence (BI) dashboard 232 (shown in FIG. 18) to display composite events made up of sub-events to allow a user to easily identify site abnormalities and take the appropriate action, as further described below. The EJS 230 is able to define application specific-events, and may be customized by the user. Also, the EJS 230 is able to define the manner in which annotation data from events and sub-events is collected, and is further able to retrieve related incidents of multimedia data efficiently in a unified view. The EJS 230 is based on the above-described event sequence mining to determine frequent episodes from collected event data and generate sequence models for detection of known sequences as well as abnormalities. For example, composite events compiled from sub-events from different multimedia sources may be produced as follows:
a. An opened cash register/POS terminal without a cashier present may be based on the combined sub-events of an opened cash register/POS terminal for a long period of time and no cashier attending that cash register/POS terminal (combination of POS event, surveillance event, extracted knowledge about the ‘how long’, and the like)
b. Loss prevention/phantom refund detection (described above), including no response from security guard when loss event occurs, etc.

As shown in FIG. 17, at step S170, the EJS 230 receives data including metadata and captured event and media data from the sensors 44, 42, 46, 210, 212, 48, 214, 216. Such metadata can include video event metadata, transaction event metadata and event metadata. In step S172 event sequence mining of this metadata is performed as described above. Thereafter, at step S174 composite application event management system creates composite events from identified abnormal sub-events. At step S176 the automated unified event journal reporting manager creates reports, alerts and/or displays for viewing on the BI dashboard 232. At step S178 a unified view of data, including composite events and sub-events, is created for display (via a viewer) on a computer 100 in the form of a GUI, and a unified communication may also be forwarded to the computer 100 in the form of other alerts.

With integration of networked services 240, the system can further support multiple store event managements including data mining, filtering, and aggregation for intelligently finding business intelligence (across multiple sites) about abnormal correlated events with an abnormal score reference. Organized views of composite events for easy viewing and searching, and automated UC notification with a multimedia recorder combining unified communication capabilities, and filtering and aggregation of abnormal events detection from system components (sensors 44, 42, 46, 210, 212, 48, 214, 216) across multiple sites.

FIG. 18 shows an exemplary event journal BI dashboard 232 which is displayable on, for example a computer display 150, in accordance with an aspect of the disclosure. The BI dashboard 232 has six areas which display information related to the site and events for easy understanding by the user (although those skilled in the art should understand that the dashboard may display greater than or fewer than six areas). Area D1 shows general information relating to the site and events, including date, customer count, number of transactions, number of events (ranked by importance) and the like. Area D2 shows a spatial, or aerial, view of the site being monitored Area D2 may be zoomed in our out depending on whether the user desires to view two or networked sites at the same time.

Area D3 shows an interactive abnormality intensity pattern viewer in which sub-events are linked using link lines L to show a composite event E5, E14, E23. D3 shows sub events for various sensor inputs 44, 42, 46, 210, 212, 48, 214, 216. While five types of sensor inputs are shown in Area D3 (camera motion, POS, AC/RFID, face detection, location/heat map), those skilled in the art should appreciate that greater than or fewer than five sensor types may be displayed. Each sensor shows sub events across Area D3 in temporal sequence, from earliest, on the left side of Area D3, to the latest, toward the right of Area D3. In this way, the user can rewind and fast forward through composite events and sub-events, much like in a digital video recorder, by, e.g., using pointing device 170 to display the desired event or sub-event. It is also noted that the composite events E5, E14, E23 are displayable in Area D1, showing the location of the composite event(s) in relation to the site.

Area D3 shows the following sensor events: camera events C1, C2, C3, C4, C5, C6, C7, C8; POS events P1, P2, P3, P4; AC/RFID event A1; face recognition event F1, F2, F3, F4; and location/heat map events L1, L2. Each sensor may be represented by a different icon or color for ease of use (here, camera events are shown by ovals, POS events are shown by rectangles, AC/RFID events are shown by pluses, face recognition events are shown by smiley faces and location/heat map events are shown by globes. Similarly, link lines L linking sub-events may be color coded or otherwise uniquely identifiable for each composite event.

Area D4 shows a camera view of the site, which could be either video or still images. The camera view could be either a live feed of the site or recorded images associated with the composite event or sub-event. Also, the camera view may be annotated with data relating to the image, such as sub-event, type of merchandise, cashier ID, and the like. Area D5 shows a list of the most recent composite events E5, E14, E23 for quick reference by the user. Area D6 shows a list of the most recent sub-events, including correlated sub-events.

It is also noted that the user can click on, mouse-over, or otherwise actuate the sub-events or composite events shown in one area of the dashboard to obtain further information in other areas of the dashboard relating to the event or sub-event. For example, by actuating composite event E14 in, the user can obtain images (and other multimedia information, including but not limited to sound, geoposition, POS data, site access data, customer information, and the like) of the composite event in area D4 and/or correlated event details in area D6.

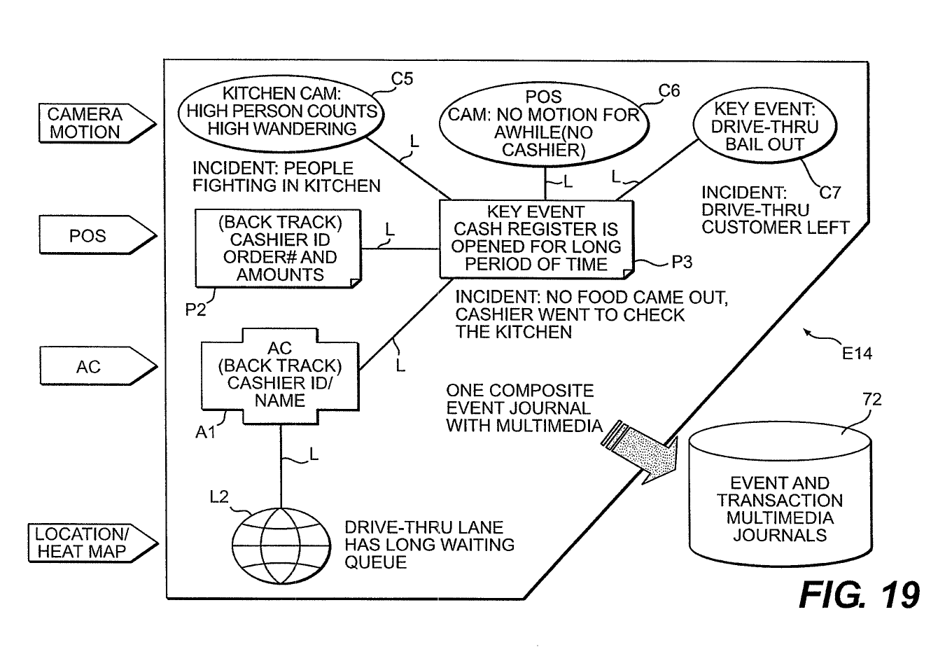

FIG. 19 shows a schematic view of a composite event E14 in the form of a composite event journal or record, which is stored in the event and transaction multimedia journal server 72. The composite event E14 includes sub-events C5, C6, P2, A1 and L2 and key sub-events C7, P3, which generally have a higher abnormality score value than “non-key” sub events. As part of a composite event, the system may include non-key sub-events C5, C6, P2, A1 and L2 based on back-tracking their correlation to the key sub-events (i.e., the importance of the non-key sub-events may not have been determined until the later key sub events have been detected).

With the above-described system BI dashboard 232 can display video and related information associated with key sub-events and non-key sub events in a unified view as a dashboard or in reports to computers 100 and mobile devices 76. The system can automatically generate journals for managers to view activities of interest based on incidence or in a business intelligence context, thereby saving the manager/user time by not requiring him or her to view lengthy recordings.

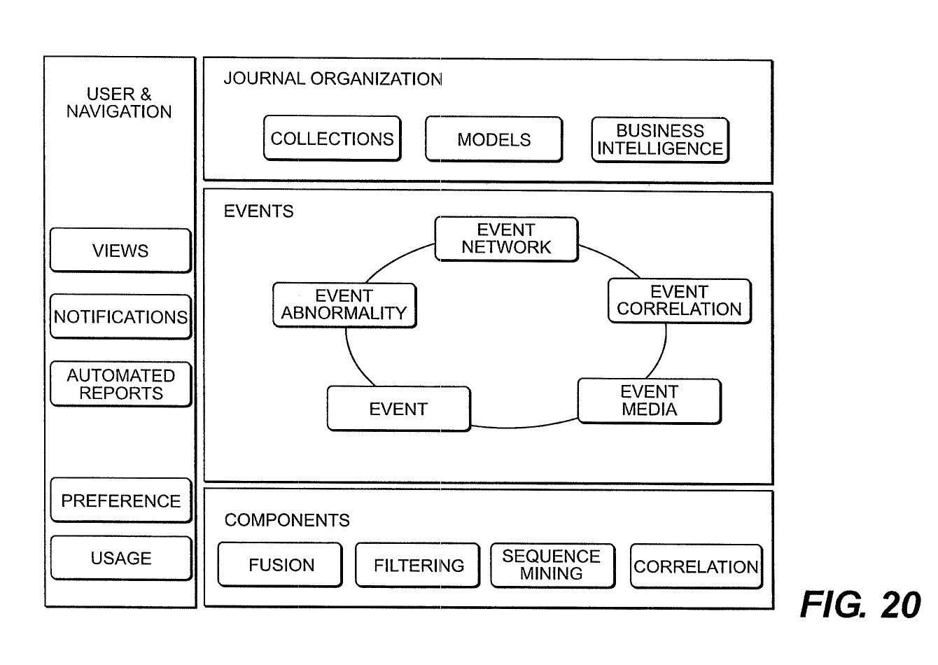

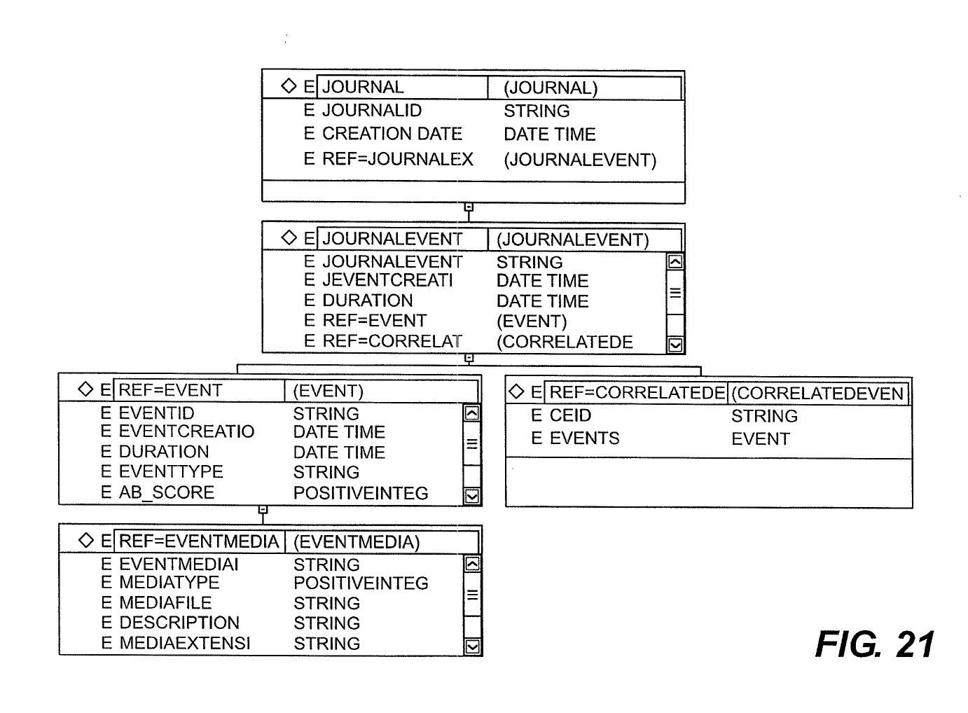

FIG. 20 illustrates an event journal server data model in accordance with an aspect of the disclosure, and FIG. 21 illustrates an event journal interface data schema in accordance with an aspect of the disclosure, which may be represented by the following sample XML code:

<?xml version=“1.0” encoding=“utf-8”?>
<xs:schema id=“EventJournalAPI” targetNamespace=“http://tempuri.org/EventJournalAPI.xsd”
elementFormDefault=“qualified” xmlns=“http://tempuri.org/EventJournalAPI.xsd”
xmlns:mstns=“http://tempuri.org/EventJournalAPI.xsd”
xmlns:xs=“http://www.w3.org/2001/XMLSchema”>

<xs:element name=“Journal”>
<xs:complexType>

```
<xs:sequence>
  <xs:element name=“JournalID” type=“xs:string” />
  <xs:element name=“CreationDate” type=“xs:dateTime” />
  <xs:element ref=“JournalEvent” />
</xs:sequence>
```

```
  </xs:complexType>
</xs:element>
<xs:element name=“Event”>
  <xs:complexType>
```

```
<xs:sequence>
  <xs:element name=“EventID” type=“xs:string” />
  <xs:element name=“EventCreationTime” type=“xs:dateTime” />
  <xs:element name=“Duration” type=“xs:dateTime” />
  <xs:element name=“EventType” type=“xs:string” />
  <xs:element name=“ab_Score” type=“xs:positiveInteger” />
  <xs:element ref=“EventMedia” />
  <xs:element name=“Description” type=“xs:string” />
</xs:sequence>
```

```
  </xs:complexType>
</xs:element>
<xs:element name=“EventMedia”>
  <xs:complexType>
```

```
<xs:sequence>
  <xs:element name=“EventMediaID” type=“xs:string” />
  <xs:element name=“MediaType” type=“xs:positiveInteger” />
  <xs:element name=“MediaFile” type=“xs:string” />
  <xs:element name=“Description” type=“xs:string” />
  <xs:element name=“MediaExtension” type=“xs:string” />
  <xs:element name=“MediaHelperProgram” type=“xs:string” />
</xs:sequence>
```

```
  </xs:complexType>
</xs:element>
<xs:elementname=“CorrelatedEvents”>
  <xs:complexType>
```

```
<xs:sequence>
  <xs:element name=“CEID” type=“xs:string” />
  <xs:element name=“Events” type=“Event” />
</xs:sequence>
```

```
  </xs:complexType>
</xs:element>
<xs:element name=“JournalEvent”>
  <xs:complexType>
```

```
<xs:sequence>
  <xs:element name=“JournalEventID” type=“xs:string” />
  <xs:element name=“JEventCreationTime” type=“xs:dateTime” />
  <xs:element name=“Duration” type=“xs:dateTime” />
  <xs:element ref=“Event” />
  <xs:element ref=“CorrelatedEvents” />
  <xs:element name=“Description” type=“xs:string” />
</xs:sequence>
```

</xs:complexType>
</xs:element>

</xs:schema>

As an example, in a situation where employees fight with each other in the kitchen of a fast-food restaurant, no food is produced during this time. Also, a drive thru customer has ordered food and the cashier has opened the register just prior to the fight. Since no food comes out of the kitchen, the cashier leaves the register and goes to investigate what is happening in the kitchen. Due to this delay, more and more drive thru customers are queued in the drive thru lane. The POS register drawer is open for a certain period of time without closing and no cashier is on the scene. Eventually, some customers decide to leave the drive thru without ordering (referred to as a “bail out” or “balk”).

As described below, an “opened register without cashier and drive-thru bail out composite event” E14 is created as a journal or record (see FIG. 19). As an example, the system first detects the POS register is in an OPEN mode for a certain period of time over the learned threshold (key sub-event) P3, the system automatically checks correlated events (e.g. security camera, etc.) and back tracking the events that might be correlated in terms of time and spatial (location proximity) factors. The system finds these correlated events to include no cashier (no movement of people) in front of POS C6 from the event journals, and back tracking to previous motion alert to find when the cashier left the register with it opened. The system also finds that there is a drive thru customer car bail out sub-event C7 which is a key sub-event. A kitchen camera also detects abnormal wandering and personnel counts in the area C5.

“Non-key” sub events are camera abnormal count and wandering events C5, POS sales event P2, no people movement (no cashier) C6 sub-events. The system organizes and links all these events together as an OPEN POS abnormality incident key sub-event and bail out key sub-event with links to related “non-key” sub event details and media (video, snapshots and the like). The detection of ‘no cashier’ can be inferred by the system from no moving object detected from video, no face detected from video of camera facing the cashier in POS terminal, or reading employee tag from wireless, etc. The condition of ‘no cashier’ can additionally or alternatively be inferred by single input or in conjunction with other inputs directly from raw data (e.g., wireless), processed data (metadata from video), or in some combination (metadata from video for motion object and face detection, or checking a color histogram of a moving object to discern whether sales associates are present or not, or checking a logo on the upper body of moving object to discern whether or not the object is a sales associate/employee, etc.).

The system shows the alert with video images on the location map in area D2 of the BI dashboard screen 232, and sends UC notifications to store manager's PC 100 and mobile device 76 automatically.

The integration of data into a unified view allows the user to digest the evidence and process the cases efficiently. The hyperlinked views of composite events (also referred to as composite event folders) provide a unique query result presentation to user, and these links allow user to move between composite event folders based on their relevance and allow the user (such as a security officer or guard) to easily comprehend a given situation. The ability to link prior multimedia LP recordings from the same or other stores allows the user to immediately see associations between these events. It allows the user to immediately evaluate the ongoing situation with instant prior data. The LP cases can also be utilized to extract common trajectories to discover favored vulnerable aisles. This can cue in the system to improve/increase system awareness (kind of a LP prediction) by: (a) improving resolution for certain areas when motion is detected or a similar face is detected, and/or (b) changing the monitored videos in front of the viewing user to increase the opportunity to catch the incident while it is happening. The system thus becomes more proactive and helpful to users in daily operations.

For example, a composite event folder may contain data from the POS record, image from one top-down camera correlated with every scan, a face image from another camera, the name of the cashier from the POS terminal, and the like. In case of organized retail crime, when the composite event folders are linked by using these available attributes as well as similarity based relevance (such as face similarity causes a link between composite event folders). The loss prevention officers can efficiently access and investigate these linked composite event folders.

The composite events are based on the primitive events that contain additional data captured by a sub-event sensor. The presenter collects dependent event data into unified view in which the data is represented in XML formatted document. This representation can be rendered or processed.

In another example, the system in accordance with a non-limiting feature of the disclosure may be used to identify a slow drive-thru and bailout situation. Where an especially large order of food is placed as a drive-thru order, this situation can occupy kitchen resources (e.g., a microwave) and slow down the production of a particular type of food (e.g., a muffin) for another drive-thru customer. The delay of this single customer can cause blocking in the head of queue of the whole drive-thru lane. As a result, customers bail out from the long and slow drive thru lane. The system in accordance with a non-limiting feature of the disclosure detects car bailout sub-events and long PUS transaction interval sub-events with long queue sub-event in the drive-thru lane. The system can readily understand the situation back-tracking to the abnormally large order sub-event with time proximity The system can thus notify the store manager or owner when the high abnormal incident happens with correlated sub-events summary information and details in the form of an abnormal composite event journal, then provide the information to manager, so that the customer who placed the large order gets pulled from the queue, whereupon he or she can receive a free order and in exchange for him/her moving out of the queue.

In a further example, the system in accordance with a non-limiting feature of the disclosure may be used to identify a situation where the operational efficiency of a cashier is slower than normal. The motion and POS events may be aggregated for each cashier and recorded in memory 120. The slow cashier can be detected and filtered out from the particular cashier's aggregated events compared with system event mining results. Slow operation can thus be easily detected.

In yet another example, the system in accordance with a non-limiting feature of the disclosure may be used to identify a situation where a cashier opens cash register without a customer present in front of refund area should trigger alarm for suspecting phantom refund. The system correlates a POS open event with video behavior event and biometric events (face detection/recognition), and finds the absence of a customer for this return transaction. The system produces a notification of possible return fraud events.

In a still further example, the system in accordance with a non-limiting feature of the disclosure may be used to identify a situation where an access control alarm is triggered, and the system generates a call to a security guard to acknowledge the alarm and handle the call accordingly. If there is no response from security guard within certain period of time which learned from past response time experience (e.g., due to either the guard being incapacitated or in league with criminal elements), the system can dispatch another call to other security guard based on skill and location data.

The present invention may operate under the following assumptions:
a. Fixed resource planning that each individual system (e.g., POS, security, drive thru services, and the like) are reasonably optimized. An experienced store manager and worker can follow the normal policy to balance the load for handling transient overload.
b. The service rate of each individual can vary (busy hour, when everyone else moves fast, or when manager present etc.).
c. The throughput of services and wait time of services are dependent on the burstyness of the order arrival and non-uniform service time due to different items ordered by customers.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission (e.g., WiFi, Bluetooth, femtocell, microcell and the like) represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A computer system for managing a workforce, the computer system comprising:
a camera that captures a video in a retail store; and
a computer connected to the camera, wherein
when the computer determines that there is a customer not being assisted by an employee and lingering in a particular place in the store based on the video captured by the camera in the store, the computer directs the employee or another employee to assist the customer lingering in the particular place while prioritizing the customer lingering in the particular place over another customer lingering in a place other than the particular place.

2. The computer system according to claim 1, wherein:
the computer determines a positional relationship between a customer and an employee in the store based on the video captured by the camera in the store, and
the computer determines that the customer is not being assisted by the employee when the determined positional relationship is outside of a predetermined value range.

3. The computer system according to claim 2, wherein the computer detects faces of the customer and the employee in the store based on the video captured by the camera in the store to determine the positional relationship.

4. The computer system according to claim 1, wherein the computer gives an alarm or generates a report when directing the employee or the another employee to assist the customer lingering in the particular place.

5. The computer system according to claim 1, wherein in a situation where there is no idle employee to assist the customer, the computer directs an employee who is assisting another customer in a place other than the particular place to assist the customer lingering in the particular place.

6. The computer system according to claim 1, wherein the particular place is a place where a high-value item is placed.

7. The computer system according to claim 1, wherein the particular place is a particular aisle.

8. A method for managing a workforce by a computer connected to a camera that captures a video in a retail store, the method comprising:
when it is determined by the computer that there is a customer unassisted by an employee and lingering in a particular place in the store based on the video captured by the camera in the store, directing, by the computer, the employee or another employee to assist the customer lingering in the particular place while prioritizing the customer lingering in the particular place over another customer lingering in a place other than the particular place.

9. The method according to claim 8, further comprising:
determining a positional relationship between a customer and an employee in the store based on the video captured by the camera; and
determining that the customer is not being assisted by the employee when the determined positional relationship is outside of a predetermined value range.

10. The method according to claim 9, further comprising:
detecting faces of the customer and the employee in the store based on the video captured by the camera in the store to determine the positional relationship.

11. The method according to claim 8, further comprising:
giving an alarm or generating a report by the computer when directing the employee or the another employee to assist the customer lingering in the particular place.

12. The method according to claim 8, further comprising:
in a situation where there is no idle employee to assist the customer, directing an employee who is assisting another customer in a place other than the particular place to assist the customer lingering in the particular place.

13. The method according to claim 8, wherein the particular place is a place where a high-value item is placed.

14. The method according to claim 8, wherein the particular place is a particular aisle.
